(19) United States
(12) Patent Application Publication
(10) Pub. No.: US 2015/0075776 A1
(43) Pub. Date: Mar. 19, 2015

(54) OPTIMIZATION OF BIOGENIC METHANE PRODUCTION FROM HYDROCARBON SOURCES

(71) Applicants: D. Jack Adams, Park City, UT (US); Aleksandra Ola Opara, Salt Lake City, UT (US)

(72) Inventors: D. Jack Adams, Park City, UT (US); Aleksandra Ola Opara, Salt Lake City, UT (US)

(21) Appl. No.: 14/339,928

(22) Filed: Jul. 24, 2014

Related U.S. Application Data
(60) Provisional application No. 61/857,772, filed on Jul. 24, 2013.

(51) Int. Cl. E21B 43/25; C09K 8/70; C09K 8/94; C09K 8/582; E21B 43/26; C09K 8/92

(52) U.S. Cl. CPC E21B 43/25; E21B 43/26; C09K 8/92; C09K 8/94; C09K 8/582; C09K 8/703
USPC 166/246; 166/250.01

(57) ABSTRACT

The present invention is directed to a method for enhancing biogenic methanogenesis in carbon-containing materials. The process includes evaluating existing geophysical conditions in a site, identifying optimal geophysical conditions for biogenic methanogenesis, introducing an enhancing fluid into the site configured to alter the existing geophysical conditions, assessing the altered geophysical conditions, comparing the altered geophysical conditions to the optimal geophysical conditions, and repeating the evaluating, introducing, assessing, and comparing steps until the altered geophysical conditions more closely resemble the optimal geophysical conditions. The enhancing fluid contains microorganisms, chemicals, and/or nutrients.

### RELATED APPLICATION

This application claims the benefit of U.S. Provisional Application No. 61/857,772, filed on Jul. 24, 2013.

### BACKGROUND OF THE INVENTION

Natural gas, oil and hydro-thermal power are the major energy sources. The potential high cost and the dwindling reserves demand the need for other sources in the energy sector. Alternative clean and efficient energy sources are of great interest. Safer and eco-friendly option of clean-green energy is the production of synthetic gases for fuels from abundant materials like coal. This is due to the fact that coal has been identified as a good source of methane, which is the primary energy source in natural gas. Thus, it is clear that the generation of methane from coal, by simple techniques, will fulfill the need for another major energy source.

Investigations are in progress, all over the world, to successfully isolate methane from coal related products by various means. Currently the worldwide production of methane from coal reaches up to seven percent. This is not enough to block the rising price of energy and the thermogenic and biogenic, energy from coal mines that needs to be extracted by systematic, environmentally sound and economical ways. Sustainable development of coal and low-grade coal bearing material conversions need to be developed to produce methane as a source of our clean energy supplies.

Bacterial degradation of coal and lignite emerged as a powerful tool for the high efficient production of methane due to the low cost over conventional thermal processes. It can be made possible, if we can properly reduce the complex structure of coal and lignite as depicted in FIG. 21. Studies have shown that acetate addition rapidly increases the production of methane from coal and the acetoclastic methogens detected by molecular approaches supports the information, indicating the need for the use of proper chemicals in this process.

So in the pretreatment process, the complex coal or lignite polymer like structure should be converted into small organic molecules by breaking the C—C bonds or C—O—C ether linkages as seen in FIG. 21. Alkaline decomposition of ether linkages should be possible or at least partial C—C bonds degradation with redox reagents/oxidizing agents such as hydrogen peroxide. Proper selection of reagents is very important in this process. We have studied a series of reagents to understand the reactivity of coal pretreatment process to facilitate bacterial biodegradation for the production of methane.

The background of this investigation started from work completed during the last century surrounding the liquefaction of coal. Currently, coal liquefaction requires high pressure and temperature in a solvent and associated with a catalyst. This is not a cost effective procedure and in fact might be more expensive than the fuel produced, and forced researchers to look for other alternatives [9]. Though, there have been numerous reports on the study of degradation of coal by bacterial action on pretreated coal, satisfactory production of methane from coal or lignite has not yet been achieved [4,8,9]. In view of this, we are exploring most environmentally friendly reagents, either directly or degradable in due course, for the fragmentation of coal and lignite. The proven reserves of natural gas in the United States amount to about 244 TCF (trillion cubic feet), while the annual consumption reaches 23 TCF. The conventional reserves of natural gas in the U.S. therefore, assuming no import is occurring, would last for roughly 10 years. Since the American economy depends as much on natural gas as it does on crude oil, the search for the unconventional resources of natural gas located within the territory of United States is ongoing. One such resource is referred to as coal-bed methane (CBM) believed for many years to be of thermogenic origin as well biogenic decomposition of organic matter occurring during early stages of coalification. Recent studies show however, that coal-bed methane may also be a renewable energy resource, produced through a microbial consumption of complex carbon compounds.

Natural gases generated from organic carbon-containing materials, such as oil deposits, depleted oil reserves, coal deposits, waste coal, shale, oil sands, waste biomass, and the like, represent an important natural energy resource. It is estimated that methane produced from such sources, other than waste biomass, currently accounts for about 20% of the world's natural gas resource. Methane and other fuel gases from these sources have thermogenic and biogenic origins. Over time, elevated temperatures and pressures contribute to the production of thermogenic methane from deeply buried organic rich materials. Microbes also degrade organic carbon-containing materials to form methane and other fuel gases, among other simple organic compounds. All microbes require certain nutrients to survive and flourish under optimal conditions. The present disclosure provides methods for identifying and creating optimal conditions for biogenic methanogenesis from hydrocarbon sources.

Accordingly there is a need for a process that enhances biogenic methanogenesis from carbon-containing materials. The present invention fulfills this need and provides other related advantages.

### SUMMARY OF THE INVENTION

The main aim of this disclosure is to show that utilization of carbon-containing materials, i.e., various types of coal or hydrocarbons, by microbes with a simultaneous production of methane is possible. Moreover, as an innovative and original approach, a chemical and/or microbial degradation of coals as a pretreatment stage is also possible with identification of new methanogenic microbial consortia.

This disclosure provides methods for enhancing biogenic methanogenesis within a site comprising a carbon-containing material. The methods comprise evaluating existing conditions within the site, identifying optimal conditions within the site for methanogenesis, introducing one or more fluids into the site containing one or more components for altering the existing conditions within the site, assessing the altered conditions and comparing the altered conditions to the optimal conditions, and optionally repeating any of the evaluating, identifying, introducing, or assessing steps. Some methods comprise single or sequential introduction of chemicals, microorganisms, and/or microbial enzymes, in any order, and by methods including, but not limited to the introduction of the materials as aerosols, fluids, encapsulated materials, and/or immobilized materials containing one or more types of microorganisms and/or microbial enzymes, chemicals, and other materials. For example, some methods comprise encapsulating one or more types of microorganisms to form a capsule, and introducing the capsule into the site. Some methods comprise introducing into the site a first fluid including one or more chemical compounds but not including any microorganisms, and subsequently introducing into the site a second fluid including one or more types of microorganisms.

This disclosure also provides fracturing fluids and methods of fracturing carbon-containing materials within a site for the purpose of enhancing methanogenesis. Some fracturing fluids comprise a consortium of one or more types of microorganisms, and one or more organic compounds, where the fluid causes the carbon-containing material to fracture when the fluid is introduced into the site. Some methods of fracturing a carbon-containing material comprise mixing one or more types of microorganisms with one or more organic nutrients to form a fracturing fluid; and introducing the fracturing fluid into the site, thereby causing the carbon-containing material to fracture. Some fracturing fluids include inorganic compounds. Some fracturing fluids include one or more components that are encapsulated. In some processes, the fracturing fluid is introduced to a site as an aerosol or foam.

The present invention is directed to a method for enhancing biogenic methanogenesis in a carbon-containing material. The carbon-containing material may include hydrocarbons, coal, tar, oil, lignite, oil sands, oil shales, depleted oil fields, organic waste products, alcohols, sugars, proteins, amino acids, lactic acid, formic acid, acetic acid, fats, and fertilizers, among others.

The process begins with the step of evaluating existing geophysical conditions within a site comprising the carbon-containing material. The geophysical conditions include physical structure, physical characteristics, and chemical/biological characteristics. Physical structure comprises the form of the site, including concentrated solids, liquids, gasses, shales, or sands, the location of the site, and the physical accessibility of the carbon-containing materials in the site. The site may be mapped using probes, core samples, photographs, spectroscopic images, ultrasound, and gas/water chemistry. The physical accessibility of the carbon-containing materials considers the relative surface area, hydrologic conditions, and geologic conditions.

Physical characteristics of the site comprise temperature, pressure, pH, redox conditions, and the types and amounts of the carbon-containing materials. The types of carbon-containing materials, i.e., sources of hydrocarbons, may include coal, tar, oil, lignite, alcohols, sugars, proteins, amino acids, lactic acid, formic acid, acetic acid, fats, and fertilizers. The chemical/biological characteristics comprise salinity, acidity, concentration of oxygen (i.e., aerobic activity in above ground deposits and anaerobic activity in some subterranean deposits), concentration of organic chemicals, concentration of inorganic chemicals, and types and populations of microorganisms. Evaluation of the types of microorganisms considers their genetic makeup, a metabolic screening, and whether the same are indigenous or foreign.

The process involves identifying the optimal geophysical conditions within the site for biogenic methanogenesis. This includes identifying optimal physical conditions, optimal biological conditions, or optimal physiochemical conditions within the site. The optimal physical conditions consider the surface area, porosity, or temperature of the site. The optimal biological conditions consider the types and amounts of microorganisms in the site. The optimal physiochemical conditions consider the concentrations of nutrients or chemicals in the site. The identifying step may include the step of determining whether the optimal physical conditions within the site require degredation of the carbon-containing material, which may include fracturing, drilling, and cavitating.

The introducing step includes the step of mixing one or more types of microorganisms or one or more types of chemicals to form the enhancing fluid. The types of microorganisms include naturally occurring, methanogens, acidophiles, halophiles, thermophiles, thermoacidophiles, nitrospirae, acidithiobacilli, pseudonomads, callulomonadaceae, aechaea, and sulfate reducing bacteria. The microorganisms are preferably genetically engineered, hybridized, isolated, or reproduced, and are obtained from ruminant animal manure, wetlands, wastewater treatment environs, bogs, and natural coal bed environs.

The introducing step may also include the step of mechanically altering the carbon-containing material in the site. Mechanically altering includes drilling injection holes; fracturing solids; inducing air cavitation; expansion or compression of fluids, aerosols, or gasses; and adjusting the temperature within surface reactors. The mechanically altering step may include injecting a fracturing fluid comprising a consortium of one or more types of microorganisms and one or more organic compounds, wherein the fracturing fluid causes a carbon source within the carbon-containing material to fracture.

The introducing step may also include encapsulating one or more types of microorganisms to form a capsule and introducing the encapsulated microorganisms into the carbon-containing material. The encapsulating step comprises combining the enhancing fluid with hydroxypropyl guars, polysaccharides, celluloses, agaroses, gelatins, alginates, guars, acrylamides, and plyacrylics.

The introducing step may also include adding chemical compounds to the enhancing fluid, wherein the chemical compounds comprise organic compounds, inorganic compounds, nutrients, redox agents, acids, bases, surfactants, enzymes, or catalysts. The method may also include the step of pre-mixing one or more types of microorganisms and one or more chemical compounds to form the enhancing fluid, such that the enhancing fluid is allowed to incubate any microorganisms are permitted to experience growth before being introduced to the site.

The enhancing fluid may comprise a liquid, an aerosol, a foam, or a mist, and may include flakes, particulates, fine meshed sands, or proppants. For nutrients, the enhancing fluid may contain a balance of Carbon, Nitrogen, Phosphorus, and Sulfur in the following ratio ranges: 80-160:5-40:0.5-15:1-5. More particularly, the balance of Carbon, Nitrogen, Phosphorus, and Sulfur is in the specific ratio of 120:20:4:1.

The introducing step comprises adding a pre-treatment fluid to the site, wherein the pre-treatment fluid comprises one or more chemical compounds without any microorganisms. Only after the pre-treatment fluid is added is the enhancing fluid introduced to the site.

The repeating step includes repeating the introducing step with a different enhancing fluid until one or more of the altered geophysical conditions is identical to one or more of the optimal geophysical conditions.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic diagram illustrating various pathways involved in biogenic degradation of hydrocarbons.

FIG. 2 is a flow chart showing methods for optimizing biogenic production of methane from hydrocarbons.

FIG. 3 is a series of representative chromatograms generated from various site samples;

FIG. 4 is a table depicting concentrations of analyzed gases generated from a Jordan River site sample in various media;

FIG. 5 is a graph depicting methane and carbon dioxide generate from the Jordan River site sample in various media.

FIG. 6 is a table depicting concentrations of analyzed gases generated from a sample of the digester sludge from a wastewater treatment plant in various media;

FIG. 7 is a graph depicting methane and carbon dioxide generate from a sample of the digester sludge from a wastewater treatment plant in various media.

FIG. 8 is a table depicting concentrations of analyzed gases generated from a Great Salt Lake wetland site sample in various media;

FIG. 9 is a graph depicting methane and carbon dioxide generate from the Great Salt Lake wetland site sample in various media.

FIG. 10 is a graph of peak areas of hydrogen sulfide generated from the Great Salt Lake wetland site sample in various media;

FIG. 11 is a table depicting concentrations of analyzed gases generated from a Great Salt Lake sediment site sample in various media;

FIG. 12 is a graph depicting methane and carbon dioxide generate from the Great Salt Lake sediment site sample in various media.

FIG. 13 is a graph of peak areas of hydrogen sulfide generated from the Great Salt Lake sediment site sample in various media;

FIG. 14 is spectra of coarse waste coal immersed in a yeast, urea and phosphate medium for various periods of time and of the medium itself;

FIG. 15 is a plot of the normalized methane concentrations and colony counts of samples that generate over 14,000 ppm of methane;

FIG. 16 is a plot of methane production from high grade coal samples inoculated with various microbial consortia with no additional nutrients added;

FIG. 17 is a plot of methane production from waste coal samples inoculated with various microbial consortia with no additional nutrients added;

FIG. 18 is a plot of methane production from lignite samples inoculated with various microbial consortia with no additional nutrients added;

FIG. 19 is a plot of bacterial growth curves;

FIG. 20 is a chart illustrating the various delivery considerations for subsurface treatments;

FIG. 21 is depiction of the complex structure of coal showing the C—C and C—O—C aliphatic bonds along with the aromatic structure;

FIG. 22A is a table showing percentage of coal/lignite consumed with different reagents;

FIG. 22B is another table showing percentage of coal/lignite consumed with different reagents;

FIG. 23 is a plot showing the percentages of reaction of coal/lignite with a variety of reagents;

FIG. 24 is a table showing the standard deviation and mean values of the reactive reagents on coal or lignite;

FIG. 25 is a plot showing the final percent reacted results of various reagents and their standard deviations;

FIG. 26 is a table showing selective reagents with 5% hydrogen peroxide and its action on coal and lignite;

FIG. 27 is a plot showing the percentages of reaction of coal/lignite with a variety of reagents and 5% hydrogen peroxide;

FIG. 28 is a table showing reaction data of corn husks with selected reagents;

FIG. 29 is a table showing reaction data of corn cobs with selected reagents; and

FIG. 30 is a table showing reaction data of corn stems with selected reagents.

### DETAILED DESCRIPTION OF THE PREFERRED EMBODIMENTS

This disclosure provides methods of optimizing biogenic production of methane from a site comprising one or more carbon-containing materials. The site may include any location that includes one or more carbon-containing materials, including underground or above ground locations. The site may include a closed system (such as a reaction vessel) or an open system. The carbon-containing materials may comprise hydrocarbons, such as those contained in coal, oil, tar, shales, oil sands, oil shales, depleted oil fields, and/or organic waste products, among others, and may be in the form of a processed or unprocessed heep, pile, deposit, agglomerate, conglomerate, or any other suitable form.

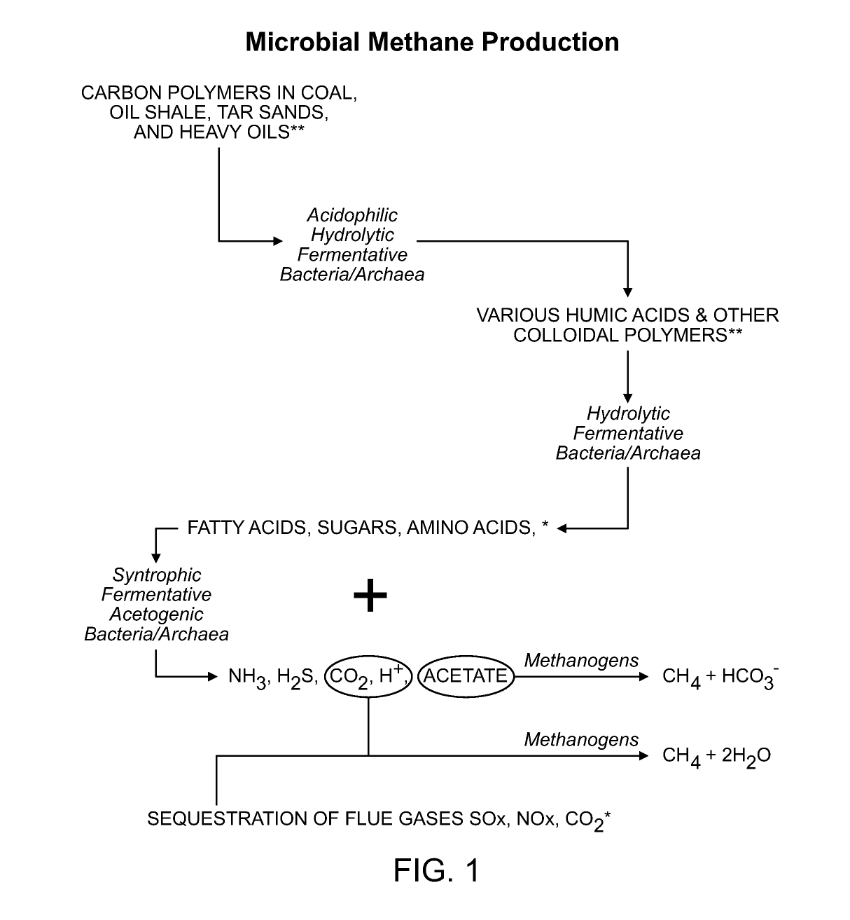

As shown in FIG. 1, microbial methane production from hydrocarbons involves several distinct pathways, each involving one or more independent microorganisms that each has different metabolic functions. Optimal conditions for each pathway, or for each microorganism involved in a pathway, may be different. As such, the ability of a consortium of microorganisms within a site comprising a carbon-containing material to process hydrocarbons to form methane depends on each of the microorganisms and the overall conditions within the site.

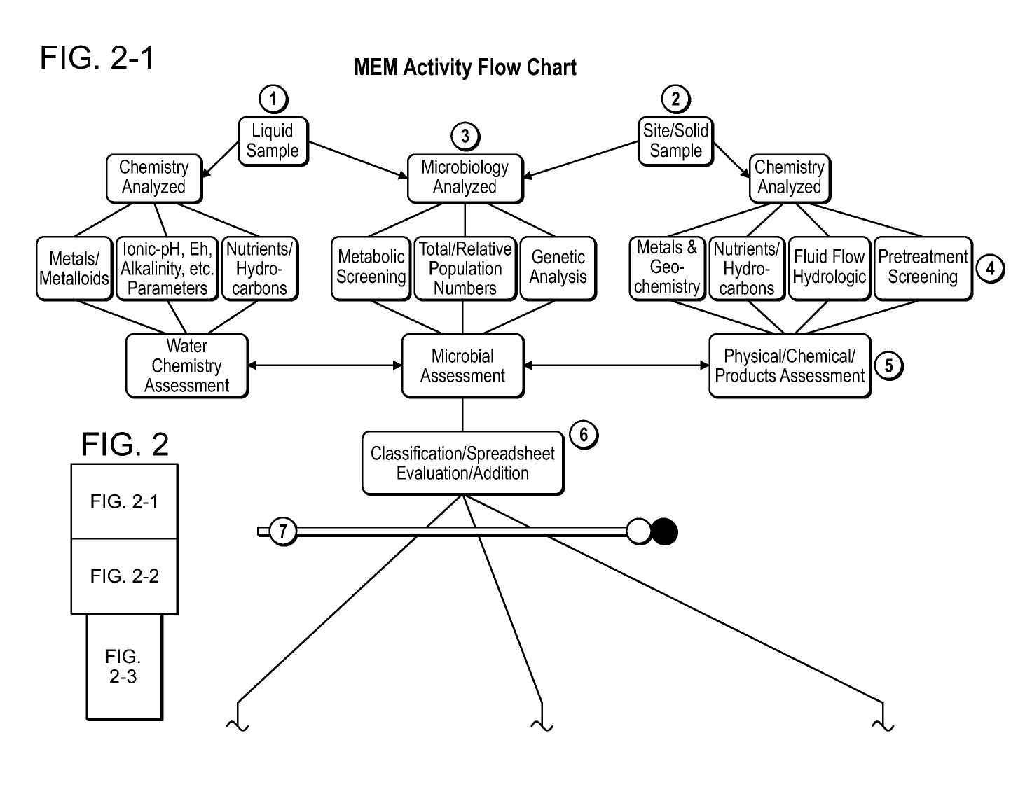

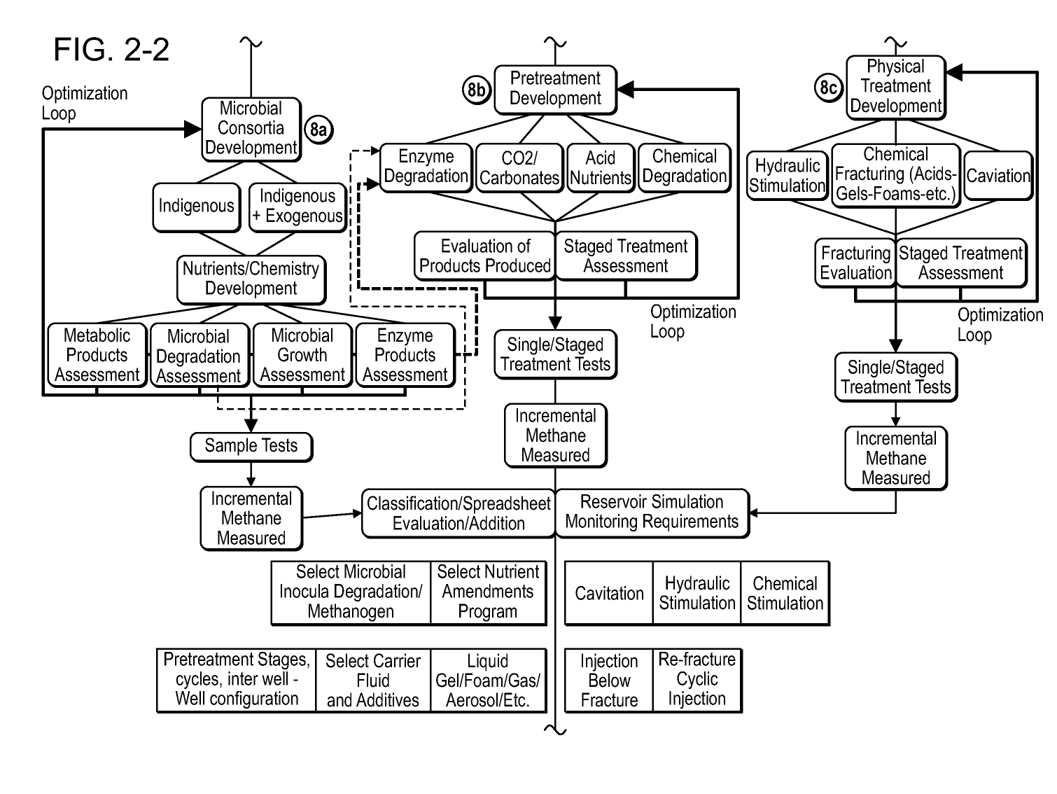

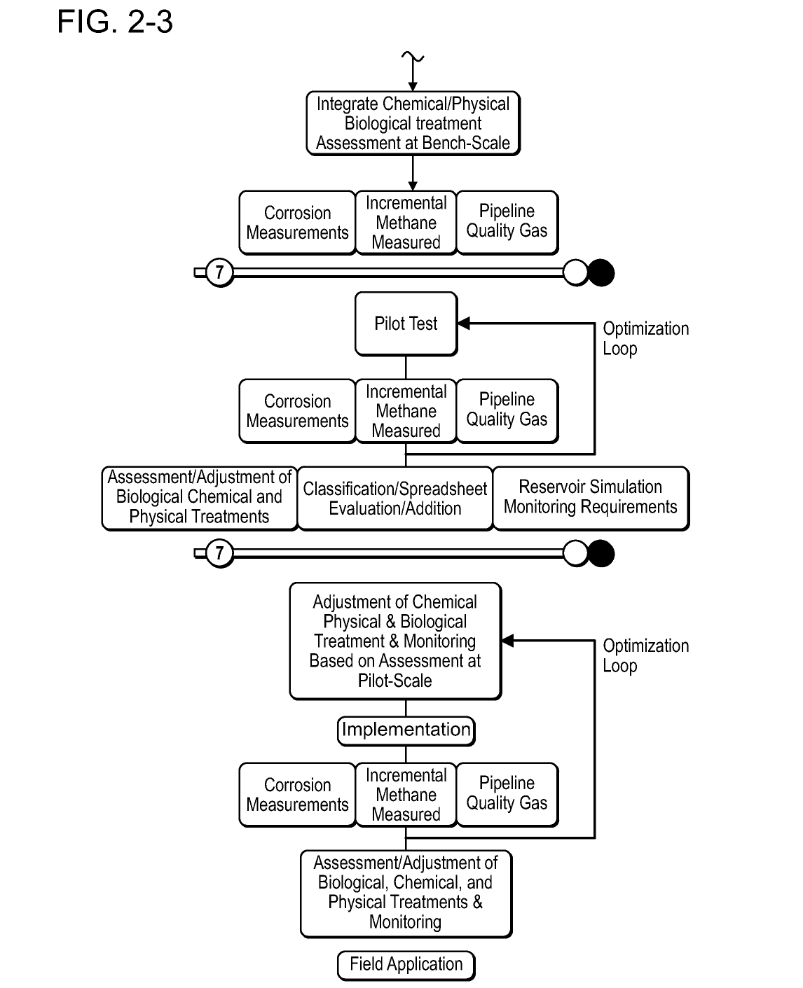

Optimizing methanogenesis is a multivariable iterative process that requires evaluating and/or controlling a wide variety of variables, and that leads to the development of an optimal microbial consortium (i.e., optimal types/amounts of microorganisms) and/or optimal geophysical conditions (i.e., optimal concentrations of nutrients, chemicals, etc.). The iterative process may be performed on a small, more easily controlled, experimental scale, or on a large scale, and may include one or more of the following steps: evaluating the existing conditions within a site (whether above ground or in situ) containing a carbon-containing material; identifying optimal conditions within the site for methanogenesis; controlling the conditions within the site to optimize the conditions; assessing the effect of controlling the conditions; and/or repeating one or more of these steps to optimize methanogenesis. These general steps, implemented under various general and specific scenarios are memorialized in FIG. 2.

Evaluate Existing Conditions within a Site.

Evaluating the existing conditions of a site containing a carbon-containing material may include evaluating the existing physical, chemical, and/or biological conditions. The conditions may be evaluated by any technique known or hereinafter devised for assessing geophysical conditions.

For example, the physical structure of a site may be analyzed and/or mapped with probes, core samples, photographs, spectroscopic images, ultrasound mapping, gas and water chemistry, or any other known, or hereinafter devised, technique. Physical attributes of a site which may be assessed include, but are not limited to, the temperature, the pH, the redox conditions, the pressure, the location, types and relative amounts of hydrocarbon sources within the carbon-containing material (e.g., coal, oil, tar, lignite, alcohols, sugars, proteins, amino acids, lactic acid, formic acid, acetic acid, fats, fertilizers, etc.), the form of the site and the carbon-containing material (e.g., concentrated solids, liquids, gasses, shales, sands, etc.), and/or the physical accessibility of the hydrocarbons (e.g., the relative surface area, the hydrologic conditions, the geologic conditions, etc.).

Samples of solids, liquids and/or gases at one or more locations within the site also may be analyzed to assess the chemical and/or biological conditions of the site. For example, solids, liquids and/or gasses may be analyzed for salinity, acidity, oxygen concentration/availability (e.g., aerobic in above ground deposits and anaerobic in some subterranean deposits), concentrations of various organic and inorganic chemicals, and/or the types and relative populations of microorganisms, such as indigenous microorganisms, as determined from metabolic screening and genetic analysis of samples.

### Experiment A

In a particular experiment evaluating the conditions in a site (or sites), the inventors studied two core sediment samples from the Great Salt Lake (sediment and wetlands), one from the Jordan River in the Legacy Nature Preserve, and a 500 mL sample of the anaerobic digester sludge from the Central Valley Wastewater Treatment Plant. The Great Salt Lake and Jordan River samples are believed to have a higher salt content.

The first core from the Great Salt Lake (GSL1) was collected from an environment where a thin layer of vegetation was sustained on sand and very little organic matter was present. The second core from the Great Salt Lake (GSL2) consisted of a thin layer of salt deposit covering a black, “gooey” material. It was very rich in organic matter and small bubbles of gas were visible during sampling. GSL2 did not hold together very well as a core. Sediments from the Jordan River (LNP) were black and very rich in organic matter. During collection of the core samples, large gas bubbles were clearly visible. An ignition of the gas collected in a plastic bag resulted in a self-sustained flame.

Seven culture media were prepared:
Yeast, urea, and phosphate (denoted as YUrPh);
Acetate (denoted as Ac);
Acetate, phosphate, and yeast (denoted as AcPhY);
Lactate media (denoted as Lc);
Control (deionized water, denoted as DI);
Tryptic Soy Broth and selenium (denoted as TSB-Se); and
50% Tryptic Soy Broth (denoted as TSB-50).

Prior to sampling, both the media preparation station and the microbial sample station were cleaned and disinfected with hydrogen peroxide. Using an automated pipettor, a 25 mL aliquot of each medium was placed in four 50 mL plastic tubes. The care was taken so that the pipettor tip did not touch the outside of the sample tubes or the media bottles. The pipettor tip was changed after each medium was sampled. The cores were cut along in half with a sterilized weighting spatula. The samples were collected from the inside of the core to avoid contamination with foreign microorganisms that could be present on the outside of the cores. Several grab points were sampled from a few points in the core in order to collect a variety of microbial communities. Each tube was filled with one of the core samples or with the digester sludge (the total of four samples). The remaining cores were wrapped with aluminum foil, placed in plastic sample bags, and placed in the fridge to preserve the natural moisture content of the sediments. Prepared sample tubes were placed in the cabinets under room temperature to allow for the microbial growth Samples were incubated in room temperature for a month and a half. A Hewlett Packard gas chromatograph (model HP6890) with a GS-GasPro PLOT column containing a proprietary, bonded silica based stationary phase was used in order to determine concentrations of gases collected in the headspace of each sample vial. Flame ionization detector (FID) was used to analyze organic compounds, while thermal conductivity detector (TCD) was used to analyze inorganic gases. The temperature program of the system began with 35° C. for 3.8 minutes to allow for carbon dioxide and ethane elution and then increased by 25° C./min to 260° C. Gas standards of the following gases were used in the preparation of calibration curves: methane, ethane, ethylene, propane, propylene, isobutane, butane, isopentane, pentane, 2-methylpentane, hexane, and carbon dioxide.

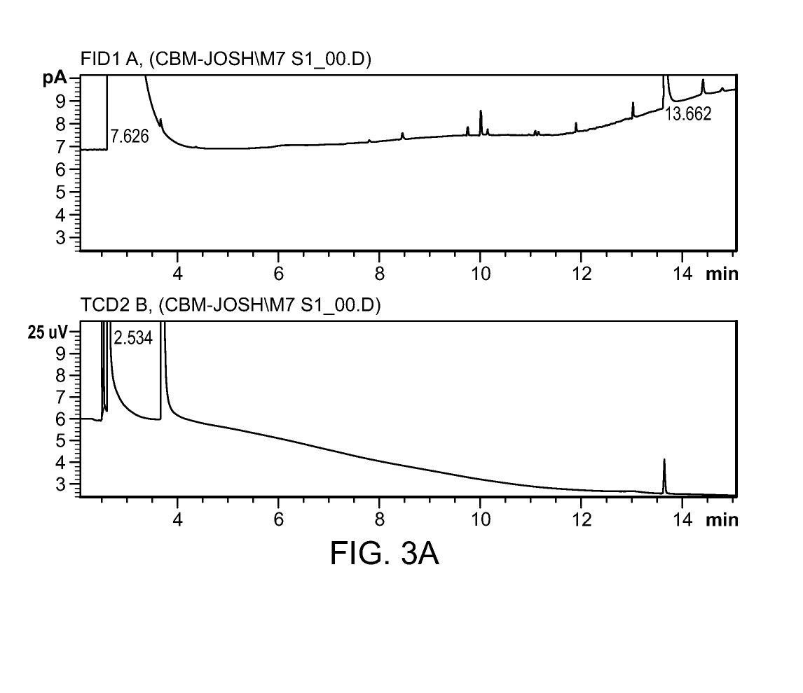

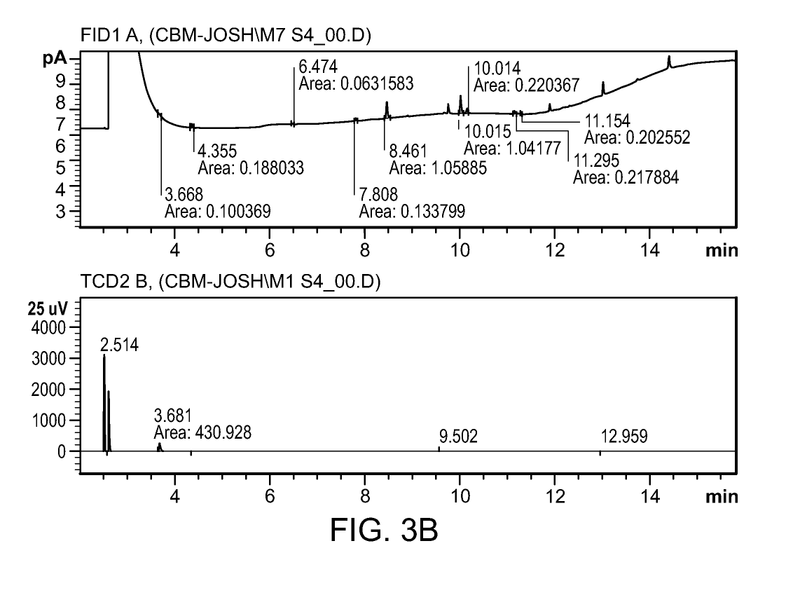

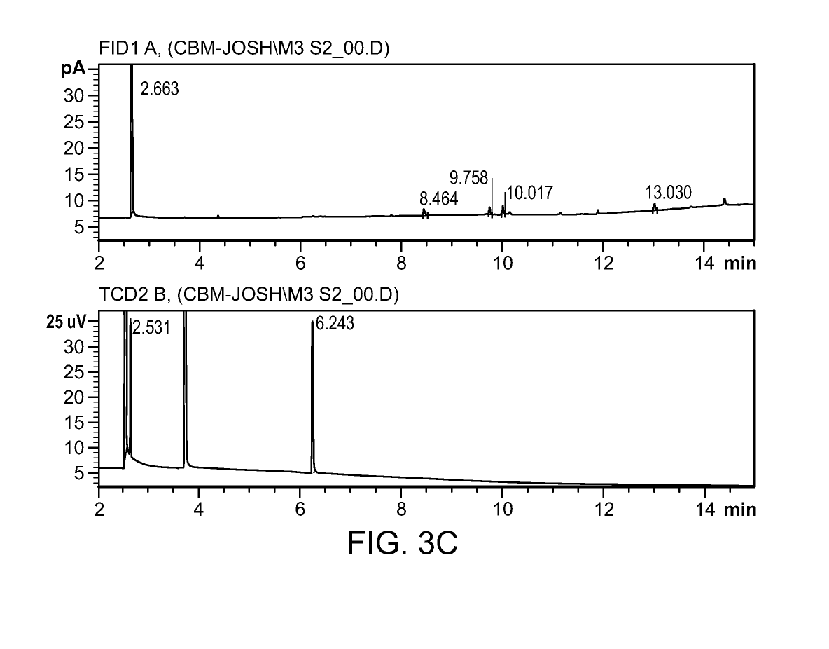

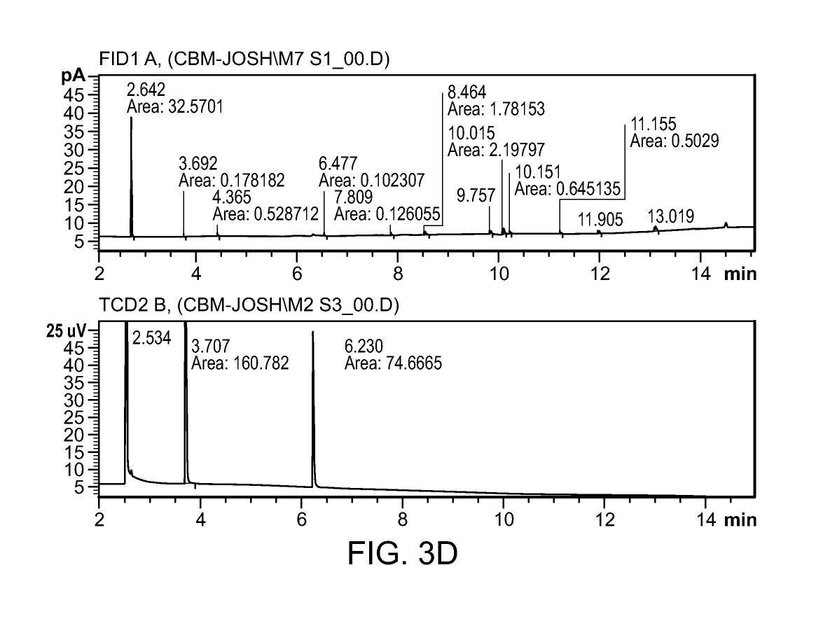

Before analysis, every tube was thoroughly mixed until the sediments were shaken and gases released into the headspace. Using a vacutainer blood collection needle, a small hole was made in tube's cap, which resulted in a considerable loss of gases from some samples. Since this was only a preliminary screening stage of the research, such a procedure was acceptable but should not be carried on into the next stages. A tip of a gastight syringe was lowered through a hole in the cap into a tube and 500 μL of the gas was drawn out. The valve was closed and the plunger was pushed to the 200 μL mark. Excess gas was released under ambient pressure into a beaker of deionized water in order to prevent contamination. 200 μL of gas was injected into a GC and the chromatogram was analyzed accordingly to the retention time of gases. FIG. 3 presents representative snapshots of chromatograms generated by the Jordan River sediments (Plot A), digester sludge from the Central Valley wastewater treatment plant (Plot B), sediments from the Great Salt Lake wetlands (Plot C), and sediments from the Great Salt Lake (Plot D). The upper portion of each chromatogram shows the organic gases (with the first peak with the retention time of 2.66 minutes being methane), whereas the lower part shows inorganic analytes (the first two peaks are the inert gases, while the third peak with the retention time of 3.7 minutes corresponds to carbon dioxide). It was noticed that there is a fourth large inorganic peak showing up on all the samples from the Great Salt Lake area (Plots C and D). The retention time of this gas was approximately 6.2 minutes and it was unknown to the technician. However, because a very characteristic “rotten eggs” smell was clearly noticeable, it was suspected that this gas could be hydrogen sulfide. A GC-MS analysis proved with 90% certainty that it was. Since at this stage of research quantitative analysis of hydrogen sulfide is not necessary, only peak areas were noted.

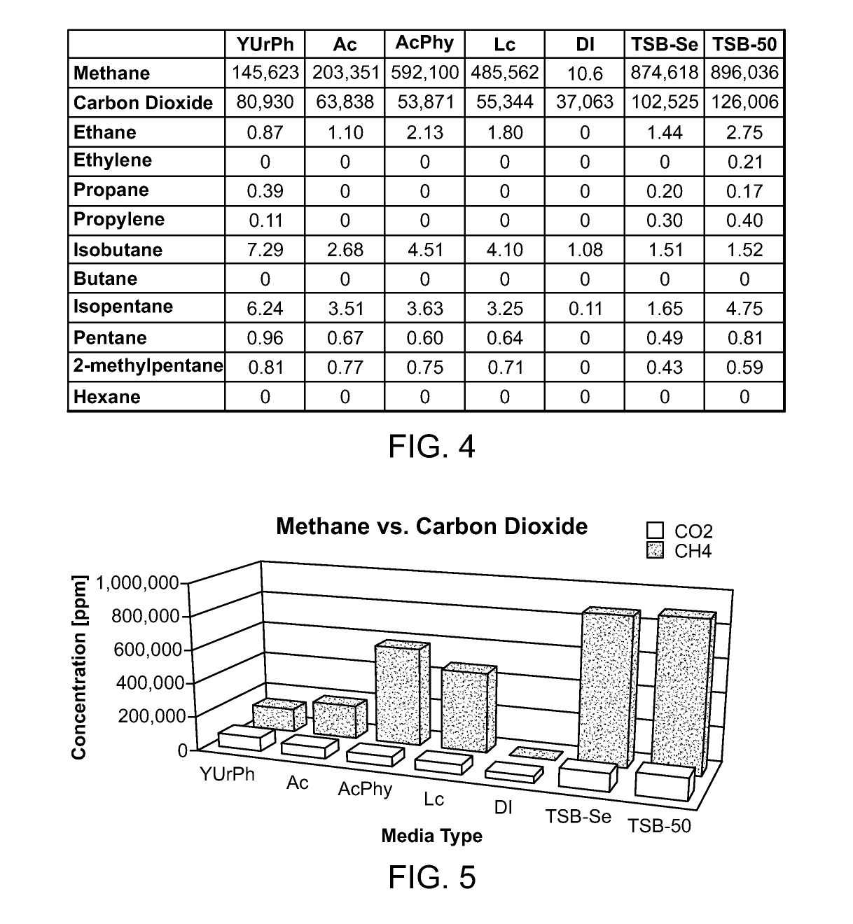

FIG. 4 is a table reporting concentrations of gases generated from the Jordan River sediments in the various media. Only methane and carbon dioxide were produced at significant levels (above 10,000 ppm). The generation of carbon dioxide generation is important since CO₂ is one of the direct precursors of methane and increases the overall methanogenic potential of the sample. Concentration of all other gases was below 10 ppm. As seen in FIG. 5, bacteria were the most active in 50% TSB medium, producing the largest amount of both methane (896,036 ppm) and carbon dioxide (126,006 ppm). The addition of selenium to TSB medium reduced the generation of these gases insignificantly. On the other hand, incubation in the deionized water resulted in the smallest productivity. There was only 10.6 ppm of methane generated (almost five orders of magnitude less than in case of the 50% TSB medium) and 37,063 ppm of CO₂. Deionized water was used as a control medium and it was expected that little gas generation will be observed. These results indicate that there was a limited amount of nutrients present in the original sediments and that most of the methane was produced from the degradation of simple hydrocarbons present in liquid media. Moreover, microorganisms harvested from the Jordan River sediments produce the largest amounts of methane while supplied with a TSB solution and fair amounts when supplied with any other type of media.

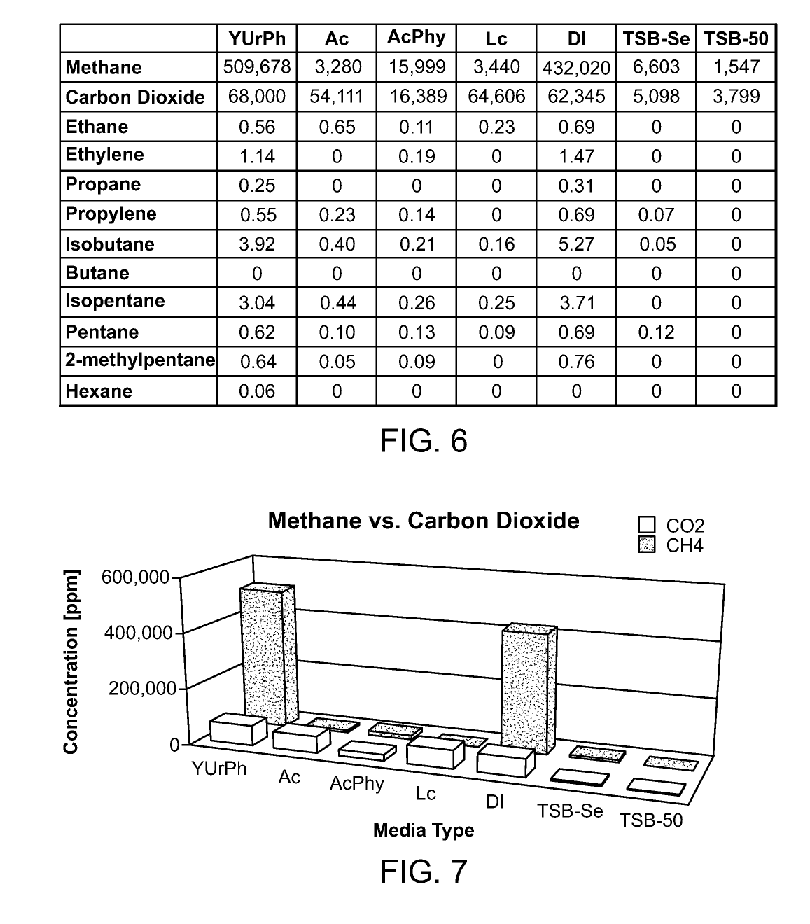

The analysis of the gases generated by the digester sludge under various conditions (FIG. 6) shows a completely different pattern from the Jordan River sediments. Only minute amounts of carbon dioxide (3,799 ppm) and methane (1,547 ppm) we produced and no other gases were detected after incubation in 50% TSB. The highest production of methane (509,678 ppm) was achieved from a mixture of yeast, urea and phosphate (FIG. 7). Surprisingly, methanogenic bacteria were also very active in the DI water sample and produced 432,020 ppm of methane. This indicates that the sample was rich in nutrients and organic matter that could be easily broken down to simple degradation products. Furthermore, even though the microorganisms present in the digester sludge were capable of producing only a little bit more than half the amount of methane generated from the Jordan River sediments, they might represent potentially interesting consortia for this research, since they performed very well without any additional nutrient or carbon source. Finally, regardless of the media type used, heavier hydrocarbons were only detected in insignificant amounts.

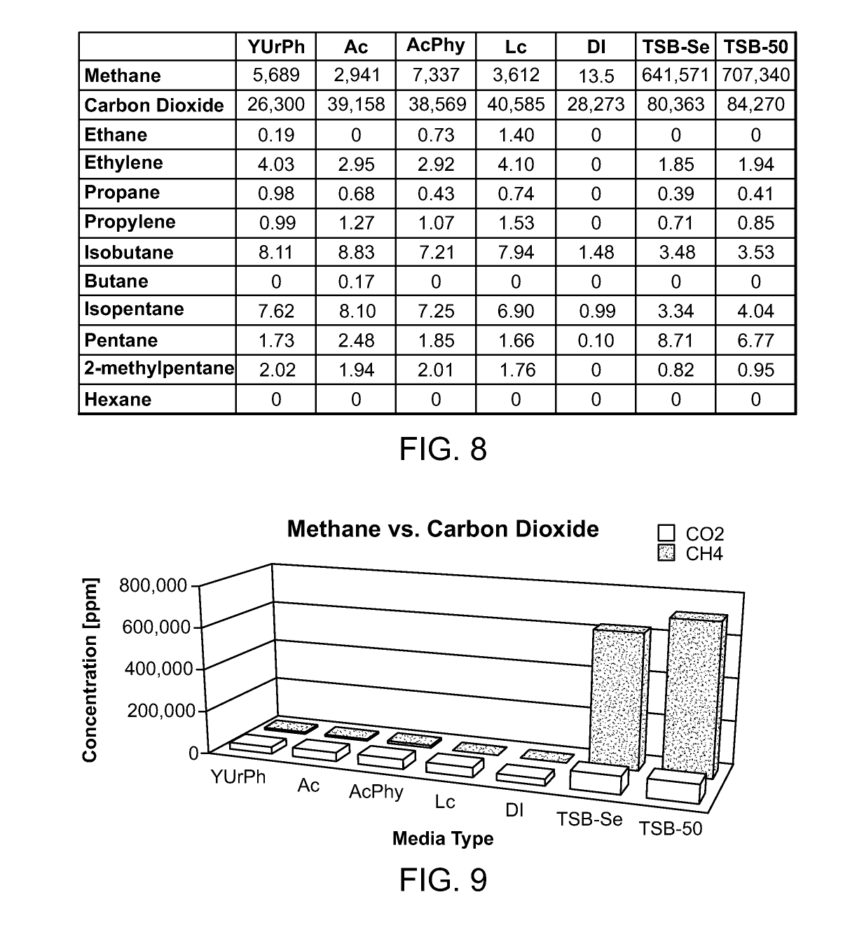

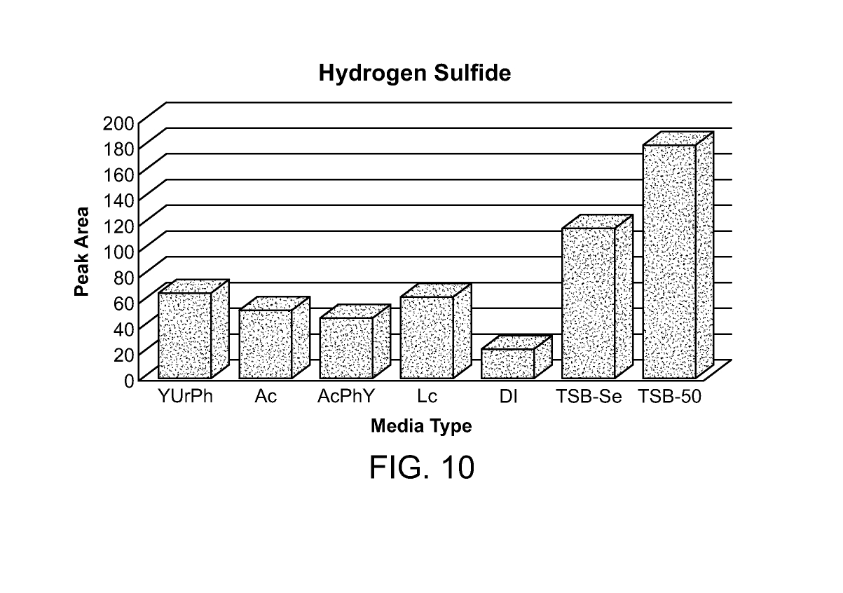

FIG. 8 shows the concentration of gases produced from the Great Salt Lake wetland sediments. The trend is very similar to the results obtained from the Jordan River sediments. The largest amounts of methane and carbon dioxide (707,340 ppm and 84,270 ppm, respectively) were produced from the incubation in 50% TSB solution (FIG. 9), while the lowest concentration of methane (13.5 ppm) was obtained from the control DI sample. Hydrogen sulfide was found in every sample and its relative peak areas are shown in FIG. 10.

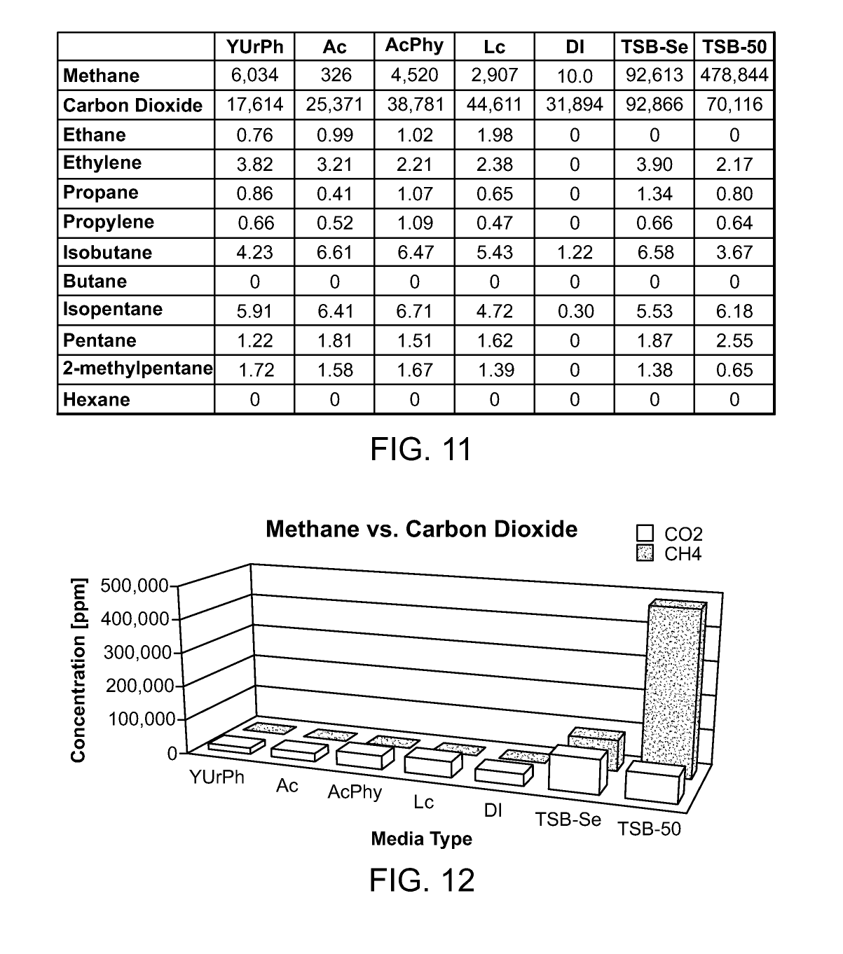

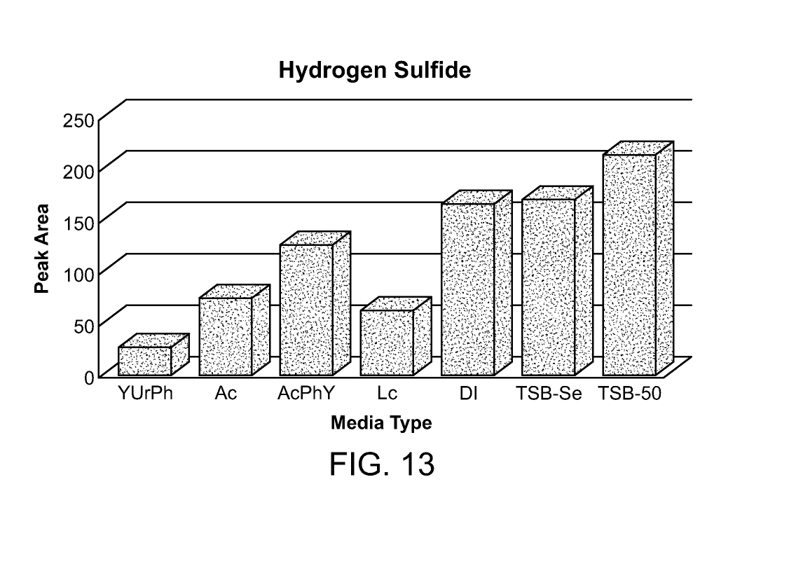

The sediments from the Great Salt Lake produced lower concentration of gases than the samples from wetlands (FIG. 11). However, they followed a similar trend and generated the largest amount of methane when immersed in 50% TSB solution (FIG. 12). Again, hydrogen sulfide was detected in all the samples and the peak areas were noted (FIG. 13).

### Experiment B

In a study of coal products, two 55-gallon drums containing high quality coal and waste rock from a coal mining site were obtained. Approximately 30 kg of each were pulverized in a ball grinder. Additionally, 30 kg of a coarse high grade coal, coarse waste rock, and waste rock soil were collected. Two core sediment samples from the Great Salt Lake's wetlands and one from the Jordan River in the Legacy Nature Preserve were collected as described above in Experiment A. Moreover, a 500 mL sample of the anaerobic digester sludge was collected from the Central Valley Wastewater Treatment Plant, also as in Experiment A. In fact, these are the exact same samples as used in Experiment A. Finally, samples from eight additional locations in the Great Salt Lake area and six locations from the Conoco Phillips coal-bed methane wells were collected.

For gas chromatography, all collected environmental samples were immersed in five selected media types and deionized water (DI). The media types included:
Acetate medium: 3.5 g/L acetate (suggested reagent: sodium acetate);
Acetate, yeast, phosphate medium: 2.5 g/L acetate (suggested reagent: sodium acetate), 0.75 g/L yeast extract, 0.5 g/L phosphate (suggested reagent: potassium phosphate monobasic);
TSB: 15 g/L tryptic soy broth;
Lactate medium: 1 g/L yeast extract, 6.667 mL/L sodium lactate, 1.23 g/L sodium acetate, 0.5 g/L ammonium chloride, 1 g/L potassium phosphate, 0.2 g/L magnesium sulfate, 0.1 g/L calcium chloride, 0.5 g/L sodium sulfate; and
Yeast, urea, phosphate: 1.25 g/L yeast extract, 0.15 g/L urea, 0.5 g/L phosphate (suggested reagent: potassium phosphate monobasic).

The environmental samples included coarse high grade coal, coarse waste rock, finely ground high grade coal, finely ground waste rock, waste rock soil, samples from eight locations at the Great Salt Lake, samples from six locations at the Conoco Phillips coal-bed methane wells, the Jordan River sediment, the Great Salt Lake sediment, the Great Salt Lake wetland sediment, and the anaerobic digester sludge. After two months, the gas was collected from the headspace of each sample and analyzed using GC.

The highest methane concentration (about 90% methane) was obtained from the two coarse high grade coal immersed in lactate media and in TSB, as well as the Jordan River sediment sample immersed in TSB. Numerous other samples produced over 50% methane. On the other hand, samples immersed in DI water usually generated very low CH4 concentrations. The highest concentration of carbon dioxide (about 40%) was obtained from the finely ground high grade coal as well as from the waste rock soil immersed in TSB. Concentrations of heavier hydrocarbons were insignificant in comparison to methane and carbon dioxide, not exceeding a few hundred ppm.

For microbial morphology and plate count, all of the environmental samples immersed in five different media and in DI water were plated on TSA plates in the dilution range of 10⁻¹ to 10⁻⁶. After three days from plating, colony morphology was characterized and colony count was performed.

For Raman spectroscopy analysis, the liquid samples from the finely ground high grade and the waste coal were immersed in five different media types and DI water. An aliquot of 3 mL of each sample was filtered through a 0.2 μm syringe filter into a glass vial and dried in an oven at 45° C. Samples were analyzed with a Raman Systems R-3000 QE portable spectrometer. A total of 30 Raman spectra were obtained, but the findings and shortcomings of the Raman analysis will be discussed on one example only.

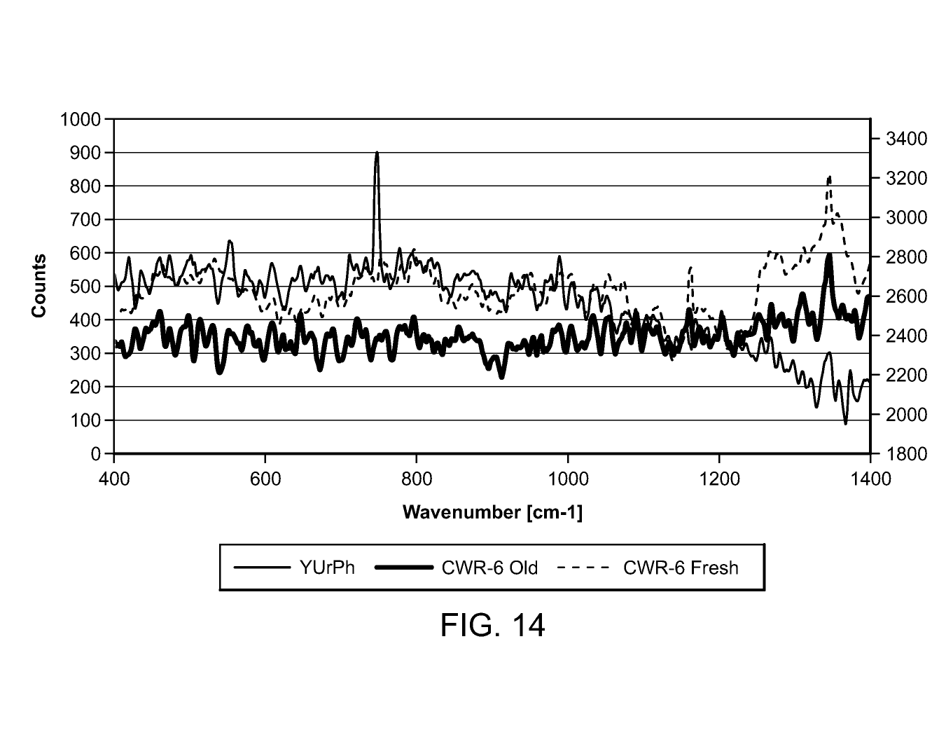

FIG. 14 shows the spectra of the coarse waste coal immersed in yeast, urea and phosphate medium. The solid thin line, representing the yeast, urea and phosphate medium on its own, has four recognizable peaks at 550, 710, 747, and 990 cm⁻¹. The S—S and C—S region is responsible for the 500 cm⁻¹ peak, as well as for the 747 cm⁻¹ peak, which may indicate the presence of proteins from the yeast extract. The 710 cm⁻¹ peak is characteristic of the deproteinated bone tissue as a result of calcium carbonate vibrations. This peak could be caused by yeast. The last peak (990 cm⁻¹) is caused by the C—H out-of-plane bending of alkenes. None of these peaks appears on the spectra of solutions taken from the coarse waste coal immersed in this medium for 48 hours (dashed line) nor for a few months (solid thick line). Two new peaks are visible on the dashed line plot—1160 cm⁻¹ and 1344 cm⁻¹. The first one is caused by the inorganic carbonates, while the latter one—by the NH₃ bending. Moreover, the spectra of the coarse waste coal immersed in the medium for a few months shows only the 1344 cm⁻¹ peak. Such results strongly indicate that the medium is being utilized. The presence of the inorganic carbonates is likely a result of decomposition of the yeast extract, whereas the ammonia is a product of utilization of urea.

Combined results of the gas GC analysis and colony count were used in designing gas generation tests. Three types of finely ground coal (high grade coal, waste coal, and lignite) were inoculated with selected microbial populations and consortia identified from previous tests. Since sustaining large microbial populations, even if they are able to produce high volumes of methane, is not feasible in a large scale commercial operation, only the samples producing the largest amount of gases and having the lowest colony count and/or the lowest number of colony types were chosen for this experiment. Four categories of populations as well as their consortia were selected (methane producers, carbon dioxide producers, producers of carbon dioxide and methane, and producers of other gases). Nutrient availability was set to three values: 0%, 10%, and 50%.

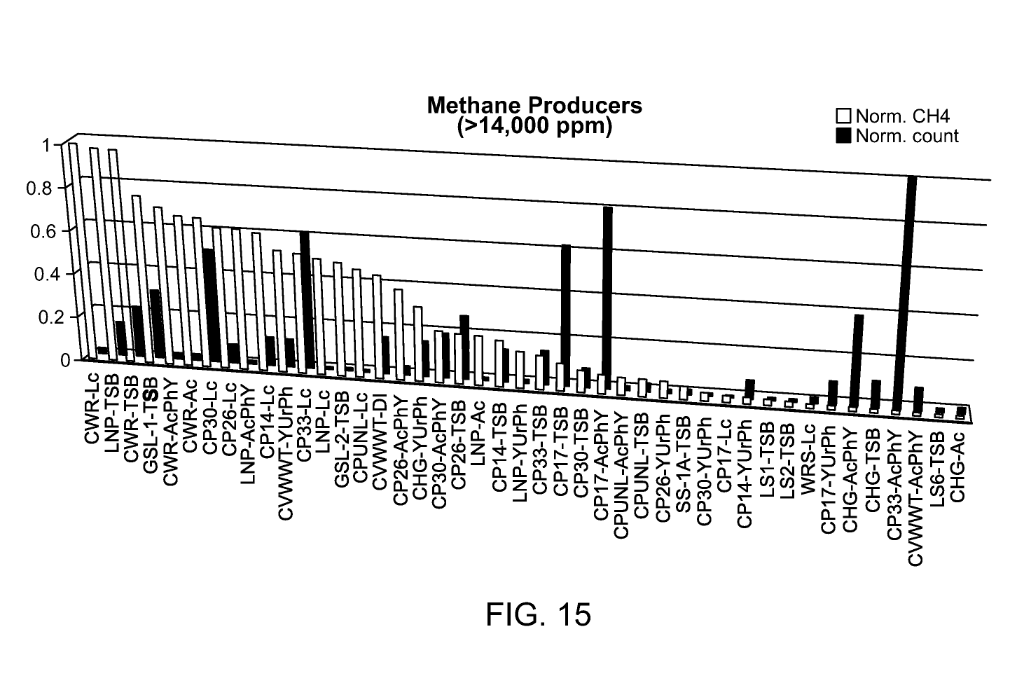

As an example, FIG. 15 shows all of the samples that generated above 14,000 ppm of methane. Detected methane concentrations and colony counts are normalized with respect to the highest values. The first six samples show desirable characteristics, high methane production and relatively low plate count, and they were among the samples that were selected for the gas generation tests. On the other hand, the last seven samples have high population numbers and produce relatively low methane concentrations; therefore, these were omitted from the gas generation test matrix.

### Experiment C

Similar to Experiment B, various hydrocarbons were immersed in various media and the results analyzed. Regarding nutrients, the desired nutrient balance of C:N:P:S (Carbon, Nitrogen, Phosphorus, and Sulfur) in the pretreated samples was set as 120:20:4:1. Elemental composition of high grade coal and waste coal samples was obtained from SGS Analysis Reports. A selected North Dakota lignite sample was assumed to have a standard composition. The elemental composition of corn was also taken to be standard.

Combined results of the gas generation tests by microorganisms in their native environments and their colony counts were used in designing the experimental matrix. Mostly the populations producing the largest amount of gases and having the lowest colony count and/or the lowest number of colony types were chosen for this experiment. Four categories of populations as well as their consortia were selected (methane producers, carbon dioxide producers, producers of carbon dioxide and methane, and producers of other gases). Microorganisms were transferred from previously prepared agar plates and grown in appropriate liquid media for about 8 days then washed and centrifuged with 0.85% w/v saline solution prior to inoculation. Additionally, liquid samples from coarse high grade coal and waste rock that have been immersed in various media for several months were used directly to inoculate some tests. Three types of finely ground coal (high grade coal, waste coal, and lignite) were inoculated in 20 mL serum bottles with selected microbial populations and consortia. Nutrient availability was set to three values: 0%, 10%, and 50%.

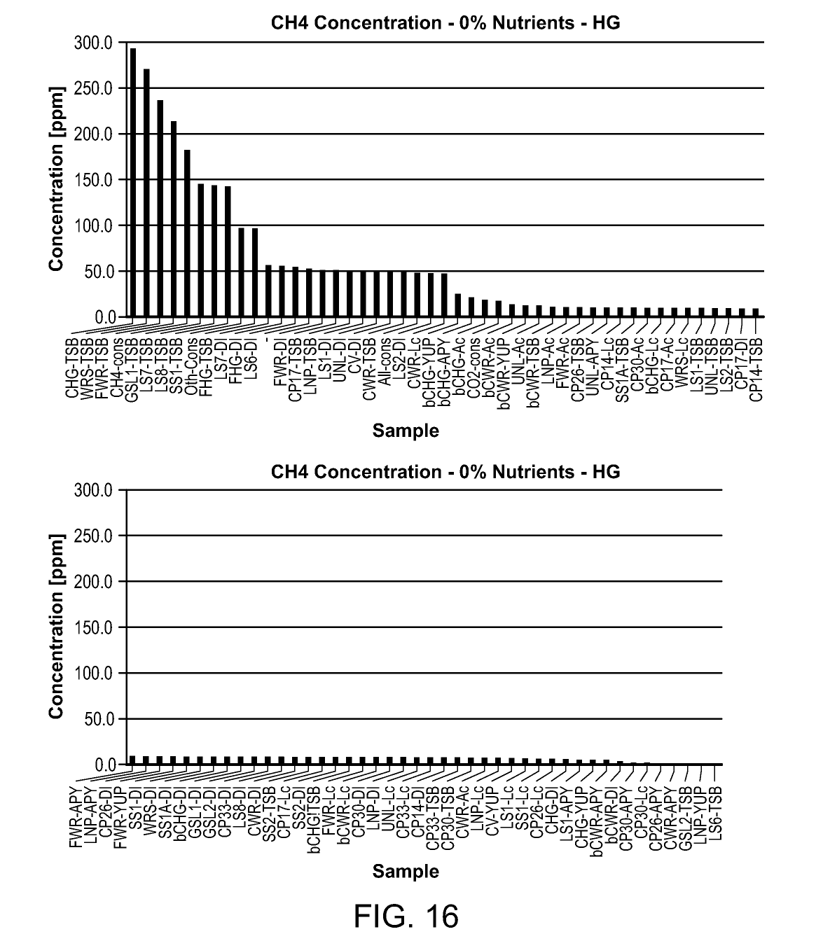

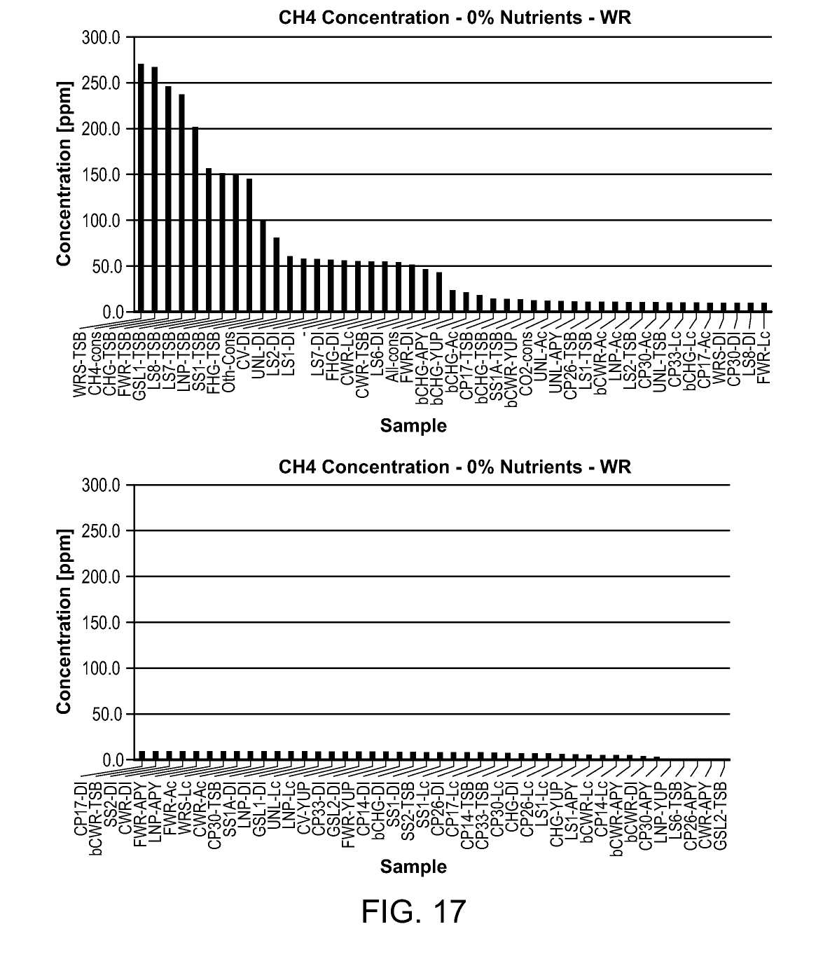

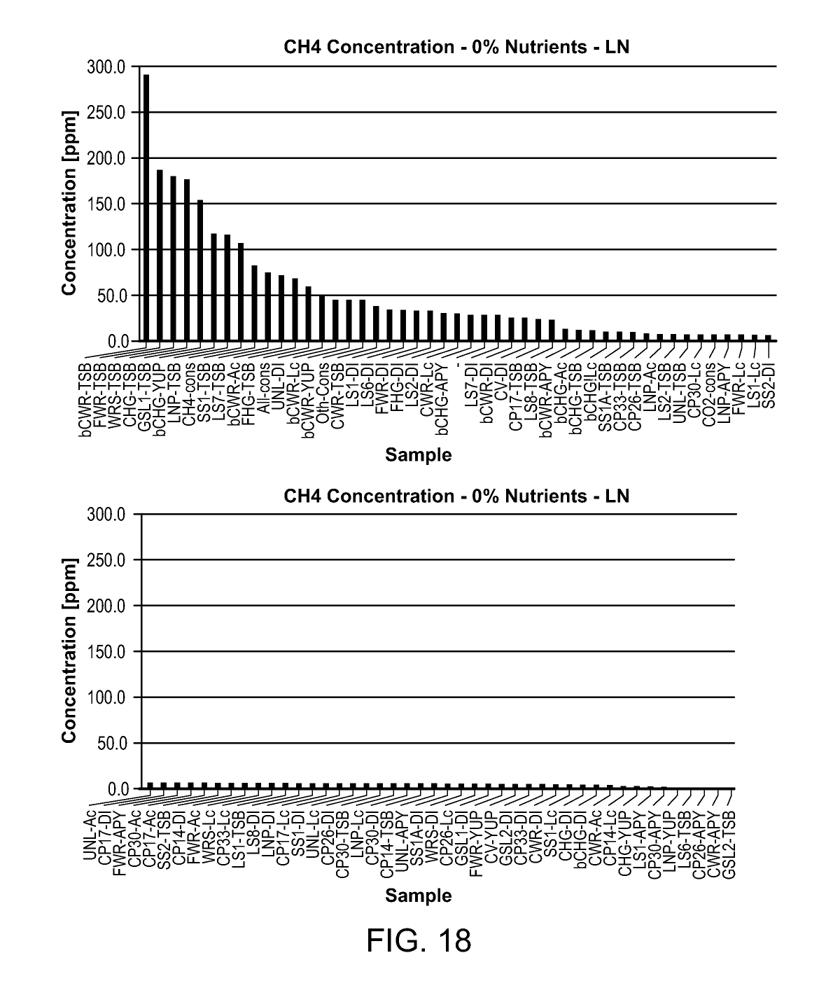

Using gas chromatography, high grade coal, waste coal, and lignite samples were inoculated with various microbial consortia and provided with 0, 10, and 50% nutrient levels. After 30 days, methane and carbon dioxide concentrations were measured. A total of 663 samples were analyzed with gas chromatography. FIGS. 16-18 show the results of high grade coal, waste coal, and lignite samples with no nutrients added. Dashed black lines represent a “control” sample, i.e., methane produced from a sample immersed in DI water without any addition of microbial communities or nutrients. As expected, samples provided with additional nutrients produced more methane and carbon dioxide. The highest gas producers out of high grade coal samples that were immersed in 50% nutrient solution produced 20% methane and 52% carbon dioxide. In comparison, the highest gas concentration produced from the high grade coal immersed only in DI water (0% nutrients) was 300 ppm CH4 and 6,400 ppm CO2. Moreover, it was clear that only a handful of tested consortia performed better than the base level denoted by the control DI sample (about 50 ppm CH4). This distinction helped select microbial consortia used in the next stage of research, where chemically pretreated samples were inoculated. Three chemical pretreatments were selected as suitable for microbial growth—acetic acid, lactic acid, and sulfuric acid. In addition to balanced tests, several unbalanced solutions were inoculated as well. Moreover, acetate spike was used on selected solutions.

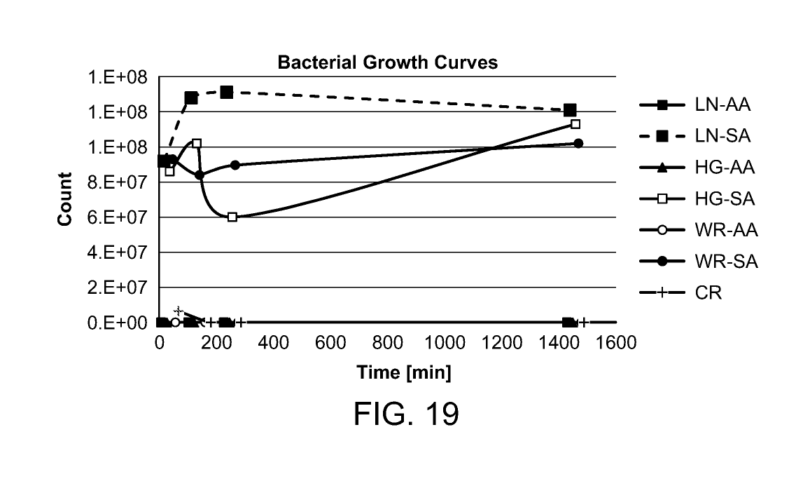

Prior to inoculation of chemically pretreated samples, microbial growth curves were prepared. For the inoculation, 10 mL of pretreated samples were placed in 15 mL plastic tubes and inoculated with 0.5 mL of previously grown microbes. The samples were vortexed and plated periodically on agar plates in 10⁻² to 10⁻⁶ dilution ranges. Indirect growth analyses, such as spectrophotometric OD measurement, could not be performed due to the high turbidity of coal samples. It was expected that the curves will follow normal microbial growth, i.e., initial lag phase followed by an exponential growth, stationary phase, and finally death phase. Results of the microbial growth experiment are shown in FIG. 19.

Three samples pretreated with sulfuric acid (curves designated with “SA”) did not follow the expected normal growth curve. However, they reached a high concentration of microbes (an order of 10⁸ colonies). On the other hand, samples pretreated with acetic acid (curves designated with “AA”) showed no growth at all. Concentrated acetic acid (and presumably lactic acid as well) produced inhabitable environment for microbes. It was calculated that lactic and acetic acid added over 90% of carbon into the solution. Therefore, dilution of the pretreated solutions would make no sense and both of these treatments were removed from the test matrix. Moreover, the dissolved corn solution proved as deadly to microbes (curve designated with “CR”). It has been proposed that it was caused by high concentration of sugars and other hydrocarbon substances. Since no external carbon was added to the corn solution (it was digested by concentrated sulfuric acid), it underwent a series of dilutions to determine the proper concentration for microbial growth. Results indicate that the microbial growth starts at about 2/100 dilution.

Identify Optimal Conditions within the Site for Methanogenesis.

The optimal conditions within a site may depend, in part, on the existing physical, chemical and biological conditions within the site. Identifying the optimal conditions for methanogenesis may be a multivariable iterative process that leads to the development of optimal physical conditions (e.g., optimal surface area, porosity, temperature, etc.), optimal biological conditions (e.g., optimal types/amounts of microorganisms) and/or optimal physicochemical conditions (e.g., optimal concentrations of nutrients, chemicals, etc.). The iterative process may be performed on small, more easily controlled, experimental scales, or on large scales, and may include selecting a microbial consortium expected to provide optimal methanogenesis, selecting achievable physical and chemical conditions expected to provide optimal methanogenesis, and/or selecting processes for introducing chemicals and/or microorganism into a site expected to provide optimal methanogenesis.

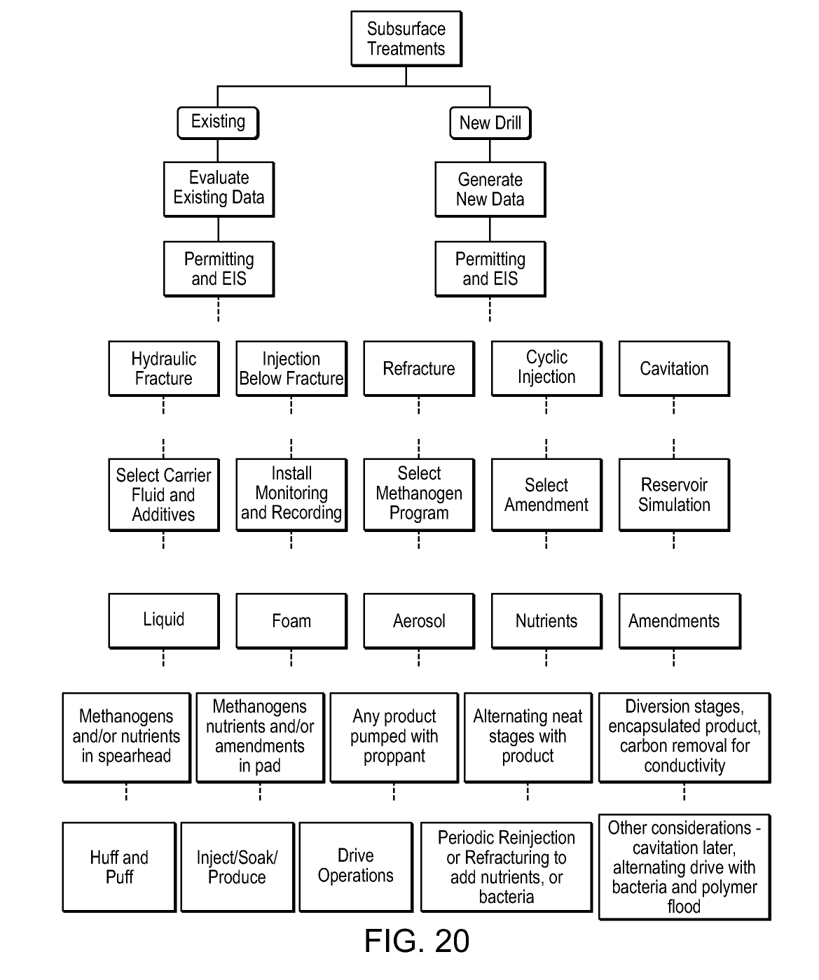

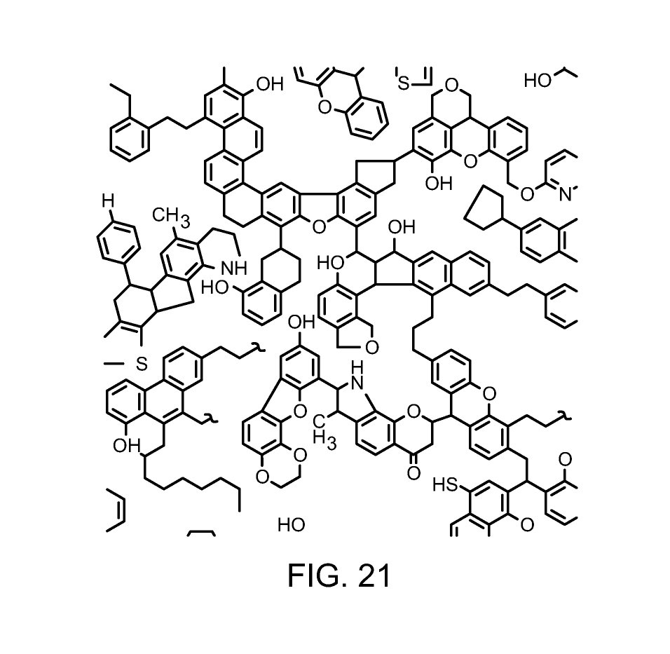

As illustrated in FIG. 20, the evaluation of sites having carbon-containing materials must consider whether the materials are on the surface or subsurface. Treatments of surface sites could be accomplished using surface reactors, leach heaps, methane capture systems, and other engineered systems. Evaluating subsurface treatments entails well known protocols depending upon whether there are existing holes or new holes must be drilled. The identifying involves assessing the carbon that is in site and available, the permeability of the site, the stresses, the transportation infrastructure, economics, and other factors. The resource assessment is conducted to ensure that enough product can be produced, considering corrosion, underground trespass, souring, breaking through seals, and undesirable byproducts.

Various processes for preparing a site include hydraulic fracture, injection below fracture, refracture, cyclic injection and cavitation. For newly drilled wells, it the permeability is less than approximately 2 md, hydraulic fracturing will be required. If the permeability is above 2 md, injection below fracturing pressure may be attempted first. It may be cycled with stages of injection above hydraulic fracturing pressure. Any number of combinations is possible. For existing wells that have been hydraulically fractured, them may be fractured with bacteria laden fluid, they may be treated at pressures below the pressure required to reopen or propagate pre-existing fractures. Cyclic injection (above/below minimum in situ stress) may be carried out. Cavitation may also be considered for stronger higher rank coals or for any coal where permeability is high enough to tolerate production without hydraulic fracturing. The above are only guidelines and any combination of technologies is feasible on a case by case basis.

Subsequent processes include: select carrier fluid and additives; install monitoring and recording; select methanogen; select amendment; and reservoir simulation. The above processes related to decisions to be made in regard to injection fluids and staging. Stage sizes are determined using conventional hydraulic fracturing or injection design protocols to place methanogens, nutrients, and amendments where desired.

The form of the fluid must next be determined. Available forms includes liquid, foam, aerosol, nutrients, and amendments. The specific fluid selected depends on reservoir conditions, relative permeability, and proppant requirements. As an example of reservoir conditions, one might consider whether is there a substantial amount of smectitic material and water consequently needs to be minimized. For relative permeability, one must consider once again whether liquid volume needs to be minimized to avoid water blockage. For proppant requirements, one must consider whether a high viscosity carrier fluid—either liquid or foam—required to carry proppant to maintain conductive channel integrity. Other considerations include: whether there are advantages to introducing carbon dioxide as the second phase in a foamed fluid; whether aerosol delivery will penetrate deeper into the formation; and whether hydraulic fracturing and high pressure are required and will denser fluids help with economics. Standard and well known engineering operations are used to design stage size, rates, and fluid selection is catered to the geologic environment and the bacterial characteristics and requirements. Nutrients may be added specifically or they may entail the treatment fluids themselves, such as guar which may be both a fluid and a nutrient. The use of encapsulated enzymatic breakers attests to this. Amendments may be added before, during, or after the treatment.

The next step involves selecting staging options: methanogens and/or nutrients in spearhead; methanogens, nutrients, and/or amendments in pad; any product pumped with proppant; alternating neat stages with product; and diversion stages, encapsulated product, carbon removal for conductivity. Product can be injected ahead of hydraulic fractures to assist in the breakdown or pressure reduction. Amendments can be injected in advance if permeability is high enough, improving methanogenesis, conductivity, and injectivity. Immediately in advance of a hydraulic fracture treatment, product can be injected followed by hydraulic fracturing or other lower pressure injection. Product can also be injected in hydraulic fracturing stages. The treatment fluid itself can be used as nutrients. To optimize the coverage of the injected product, diversion can be used (100 mesh sand, benzoic acid flakes, and other hydraulic fracturing products). Certain types of bacteria could be considered to remove channels adjacent to natural or hydraulically injected fractures, creating additional conductivity. Removal or alteration of carbon by amendments or bacteria may also lead to increases in permeability. An important component is the use of encapsulation technologies to allow placement of bacteria, enzymes, nutrients, or amendments. The final task is the design and implement reservoir management protocols, i.e., “Huff and Puff”, inject/soak/produce, drive operations, periodic reinjection or refracturing to add nutrients or bacteria, and other considerations, such as, cavitation, alternating drive with bacteria and polymer flood.

Introducing Enhancing Fluids for Altering Existing Conditions

Selecting a microbial consortium expected to provide optimal methanogenesis depends on the existing physical, chemical and biological conditions within a site comprising a carbon-containing material, and the desired and/or expected physical, chemical and biological conditions after they have been modified by an interventive process. All microbes require specific nutrients, vitamins, minerals, electron donors/acceptors, etc. to grow and have metabolisms that break down organic compounds in a specific manner and rate that depends on its surrounding environment. As such, a wide variety of factors may need to be considered in identifying specific microbes that could be added to a carbon-containing site to form an overall microbial consortium (i.e., endogenous plus exogenous microbes) that is most efficient at fonning methane from a carbon-containing material.

The overall microbial consortium may include one or more microorganisms, including, but not limited to, naturally occurring, genetically engineered and/or hybridized methanogens, acidophiles, halophiles, thermoacidophiles, thermophiles, nitrospirae (e.g., Leptospirillum, such as Leptospirillum ferriphilum, Leptospirillum ferrooxidans, Leptospirillum, sp., etc.), acidithiobacilli, pseudomonads (e.g., Pseudomonas sp.), cellulomonadaceae (e.g., Cellulomonas sp.), archaea, sulfate reducing bacteria, etc. Notable methanogens include, but are not limited to, Methanobacterium (e.g., Methanobacterium formicicum), Methanobrevibacters (e.g., Methanobrevibacter ruminantium), Methanosphaera (e.g., Methanosphaera stadtmanae), Methanococcus (e.g., Methanococcus vannielii), Methanothermobacter (e.g., Methanothermobacter defluvii), Methanothermococcus (e.g., Methanothennococcus thermolithotrophicus), Methanothermus (e.g., Methanothermus sociabilis), Methanocaldococcus (e.g., Methanocaldoccocus jannaschii), Methanolinea (e.g., Methanolinea tarda), Methanomicrobium (e.g., Methanomicrobium mobile), Methanosarcina (e.g., Methanosarcina barkeri), Methanoculleus (e.g., Methanoculleus bourgensis), Methanofollis (e.g., Methanofollis tationis), Methanohalobium (e.g., Methanohalobium evestigatum), Methanogen um (e.g., Methanogenium cariaci), Methanohalophilus (e.g., Methanohalophilus mahii), Methanolacinia (e.g., Methanolacinia paynteri), Methanolobus (e.g., Methanolobus tindarius), Methanoplanus (e.g., Methanoplanus limicola), Methanosalsum (e.g., Methanosalsum zhilinae), Methanomethylovorans (e.g., Methanomethylovorans hollandica), Methanocalculus (e.g., Methanocalculus halotolerans), Methanosaeta (e.g., Methanosaeta concilii), Methermicoccus (e.g., Methermicoccus shengliensis), Methanospirillum (e.g., Methanospirillum hungatei), Methanocella (e.g., Methanocella paludicola), and/or Methanopyms (e.g., Methanopyrus kandleri). In some cases, selected microorganisms (or consortium of microorganisms) may be obtained, isolated, reproduced, and/or engineered from bacterial samples obtained from ruminant animal manure, wetlands, wastewater treatment environments, bogs, natural coal bed environments, and/or other locations typically known to produce high concentrations of methane from decomposition of organic compounds.

In some embodiments, the selected microorganisms may be “ultra-micron” microorganisms, which range in size from 1/10 to 1/100 the average size of normal bacteria. The reduced size of the selected microbes may allow the microbes to penetrate into substantially smaller spaces within the matrix of a solid material when introduced (e.g., injected) into a site comprising a carbon-containing material. In some embodiments, the selected microorganisms may be starved microorganisms (i.e., microorganisms that have been maintained under low nutrient conditions until they reduce in size). As with ultra-micron microorganisms, the reduced size of starved microorganisms may allow the microbes to penetrate into substantially smaller spaces within the matrix of a solid material. It should be appreciated that ultra-micron microorganisms may or may not be starved microorganisms. The selected microbial consortium also may be optimized to include specific relative amounts of the various microorganisms.

Selecting achievable physical and chemical conditions expected to provide optimal methanogenesis also depends on the existing physical, chemical and biological conditions within a site comprising a carbon-containing material, and the desired and/or expected physical, chemical and biological conditions after the conditions have been modified by some interventive process. Some physical and chemical conditions within a particular site may not be very controllable, or only may be slightly controllable (e.g. temperature and pressure), whereas other conditions may be controlled via mechanical means and/or by adding (e.g., injecting or otherwise depositing) chemicals or other compounds into the site. For example, the physical conditions within a site may be altered to optimize surface area and/or to place compounds within the site in a condition more amenable to bacterial processing, such as by using mechanical means (e.g., drilling, cavitation, etc.) and/or chemical means (discussed below) to alter the formation and/or degrade solids and liquids. The chemical conditions within a site may be altered in a manner that affects the physical conditions and/or provides the most optimal balance of chemicals for a particular bacterial consortium to grow and degrade organic compounds in a desired and optimal manner. In some cases, optimal chemical conditions may be pre-existing within the site. Examples of chemicals/compounds that may be pre-existing within a site and/or may subsequently be added to a site to improve the conditions for optimal methanogenesis include, but are not limited to organic compounds, inorganic compounds, nutrients, redox agents, acids, bases, surfactants, enzymes and other catalysts.

Organic compounds that may be pre-existing within a site and/or may subsequently be added to a site include, but are not limited to, complex hydrocarbons (e.g., oil, coal, lignite, tar), alcohols, ethers, ketones, aldehydes, carboxylic acids, esters, acid anhydrides, amides, carbohydrates (e.g., sugars, starches, and/or cellulose materials, among others), proteins, amino acids, lactic acid, formic acid, acetic acid, fats, fatty acids, gels, agars, alginates, guar, etc.

Inorganic compounds that may be pre-existing within a site and/or may be subsequently added to a site include, but are not limited to, mono-, di-, and tri-valent minerals/metals/salts such as inorganic compounds including Ni Fe, Mg, Mn, Ca, K, P, S, Na, carbonates, phosphates, sulfates, nitrates, chlorides, sulfides, hyrdoxides, oxides, silicates, etc. Redox agents include any naturally or non-naturally occurring oxidizing agent (e.g., ozone, various oxides, hydrogen peroxide, permanganate, etc.) or reducing agent (e.g., oxalic acid, formic acid, ascorbic acid, phosphites, hydrophosphites, sulfites, nascent hydrogen, etc.).

Acids may be introduced to a site to degrade hydrocarbons (e.g., coal) or other physical structures, to amend or adjust the chemical environment (e.g., the pH), to provide nutrients, and/or to donate hydrogen atoms. Examples of acids that may be introduced to a site include, but are not limited to, strong acids (e.g., hydrochloric and sulfuric acids, among others), and weak acids (e.g., citric acid, acetic acid, nitric acid, and lactic acid, formic acid, oxalic acid, and uric acid, among others). Some acids may be introduced to a site containing a carbon-containing material for multiple reasons. For example, lactic and/or nitric acids may be introduced to a site to degrade coal and/or other carbon-containing material into simpler components, and to provide leftover lactate and/or nitrate that can be used as a nutrient for various bacteria (lactic acid is a primary nutrient that will produce additional methane, and nitric acid provides nitrogen and possibly oxygen needed by some microbial/genera/species for growth).

Bases also may be introduced to a site to degrade hydrocarbons or other physical structures, to amend or adjust the chemical environment (e.g., the pH), to provide nutrients, and/or to donate hydrogen atoms. Examples include, but are not limited to, ammonium hydroxide, sodium hydroxide, potassium hydroxide, calcium hydroxide, ammonium carbonate, sodium carbonate, potassium carbonate, calcium carbonate, sodium bicarbonate, and calcium oxide, among others.

Surfactants may be added to a site to function as welling agents, emulsifiers, foaming agents, and/or dispersants. Surfactants often are organic compounds that are amphiphilic, and may be used to amend or modify the geophysical environmental or provide nutrients. Examples include, but are not limited to, SDS, CTBA, Triton X, CHAPS, polysorbates, cetyl and stearyl alcohols, among others.

Enzymes and other catalysts may be used to amend or modify the geophysical environment, may function as microbial nutrients, and/or may regulate microbial cellular or metabolic functions. Examples of enzymes include, but are not limited to, oxidoreductases, transferases, hydrolases, lyases, hgases, and general microbial and other extracts. Examples of other catalysts include, but are not limited to, platinum, palladium, sodium-manganese and nickel containing materials.

The optimal types/amounts of the various specific chemicals/compounds within a site for methanogenesis depends on the pre-existing conditions of the site, and on a selected bacterial consortium. However, experiments have shown that optimal chemical conditions generally provide a relative balance of carbon, nitrogen, phosphorous, sulfur, potassium, trace minerals and vitamins (see Appendices A-D). For example, chemical conditions that provide C:N:P:S ratios of about 80-160: about 5-40: about 0.5-15: about 1-5 provide for more efficient methanogenesis.

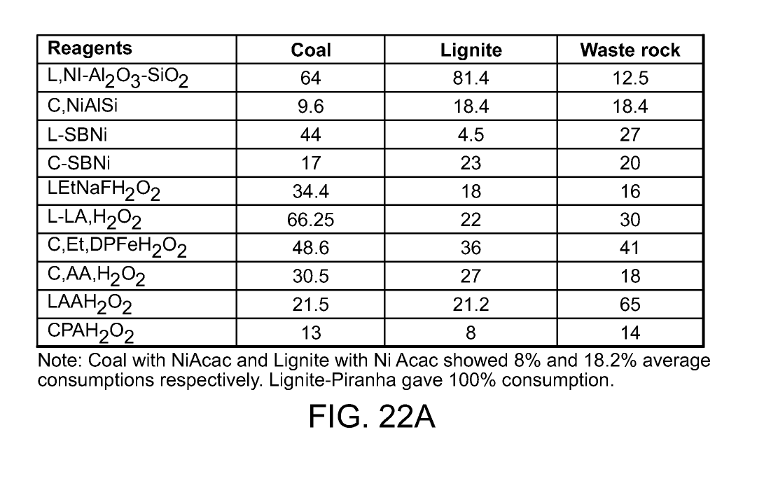

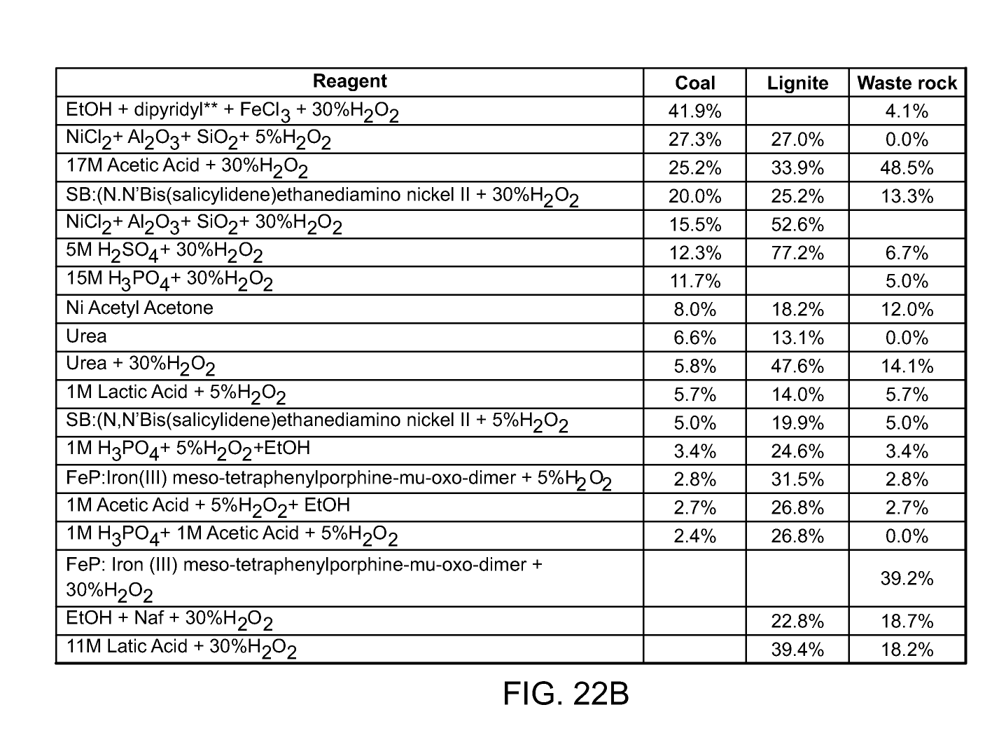

Generally, chemicals and microbes are delivered as fluids and/or micro-solids to carbon-containing sites at the surface or in subterranean formations. Fluids containing reagents such as chemicals and/or microbes may be delivered via processes that provide optimal conditions for methanogenesis. Some of these reagents as have been reacted with coal and lignite in order to investigate their reactivity. As reported in FIGS. 22A and 22B, the percentage of reactivity or degradation of each reagent is as follows:
Sulfuric acid: Both coal and lignite were individually treated with sulfuric acid and sticky black mass was obtained. Ethanol solutions of coal and lignite were also reacted with sulfuric acid and the resulted mass was similar. The action of surfactant triton-100× was the same leaving behind a black mass. The weights were more than the quantity taken for initial reaction. The evaporated filtrate did not give any desired peaks in Raman spectra.
Ammonium Hydroxide: The reactivity of ammonium hydroxide was very negligible and no color change could be seen with coal. Though there was a slight yellow filtrate left with lignite and ammonium hydroxide, the percentage of reactivity was almost nil in both the cases. Ethanol medium of coal and lignite and presence of triton X could not activate the reaction.
30% Hydrogen Peroxide: The action of hydrogen peroxide was vigorous especially that of lignite with ethanol. But hydrogen peroxide alone was not a suitable reagent as it reacted with only 3% of the coal mass.

Pyridine: Pyridine did not show any reaction either on coal or lignite under any conditions. Moreover, pyridine is not an environmentally friendly reagent.
Tetrafluoroboric acid: There was some vigorous reaction with perfluoroboric acid with lignite. But the weight loss experiment was not successful.
Magnesium perchlorate in 50% ethanol-water mixture: No considerable reaction occurred with this reagent as evidenced by the weight loss experiment and Raman. Moreover, due the explosive nature of perchlorates, we did not continued additional experiments with this reagent.
NaF and H₂O₂ The reaction between sodium fluoride and hydrogen peroxide on coal and lignite was examined. Coal did not reacted with these reagents under any conditions studied, whereas lignite has an average reactivity of about 22% in ethanol.
HNO₃ Though nitric acid reacted vigorously with coal and lignite, the weight loss experiments did not give any indication of coal or lignite consumption reactions occurring. This was further confirmed by the Raman spectra on the evaporated filtrate.
Piranha (1:1 H₂SO₄ and 30% H₂O₂) (Slow addition and with caution): With 1:1 mixture of concentrated sulfuric acid and 30% hydrogen peroxide, there was a complete consumption of lignite in the ethanol medium. The reaction was vigorous and even reactive in a 10% solution of hydrogen peroxide with 1M sulfuric acid for 10 days. Detailed experimental results are tabulated.
Acetic acid and Hydrogen peroxide: The combination of acetic acid with hydrogen peroxide seems to be a promising reagent for both coal and lignite. The mean percentages of coal and lignite reacted were 25 and 33.9 respectively. Lignite reacted more with acetic acid-hydrogen peroxide mixture than coal.
Lactic acid and Hydrogen peroxide: There was no reaction of lactic acid-hydrogen peroxide on coal. Lignite reacted about 39% with this combination with a standard deviation of 23.
Phosphoric acid and hydrogen peroxide: Systematic experiments were performed with phosphoric acid-hydrogen peroxide combination on coal and lignite respectively. Unlike from other reagents, coal reacted about 11% with this reagent where as the lignite reaction was almost zero. The standard deviation for coal with this experiment was 3.
HCl and H₂O₂: Hydrochloric acid with hydrogen peroxide reacted vigorously with no apparent consumption of coal or lignite as evidenced by the percentage of coal/lignite weight loss.
NiCl₂—Al₂O₃/SiO₂ Motivated by the recent work carried out with Pt/SiO₂—Al₂O₃ by Huber et al [10] on sorbitol types of molecules for aqueous-phase hydrodeoxigenation under specific conditions, we are herewith introducing a new NiCl₂ combination with alumina and silica catalytic reaction for the decomposition of coal and lignite under ethanol-water mixture. Both coal and lignite responded with this reagent; it consumed an average of 52% lignite and 15% coal respectively. The standard deviations were 35 and 5 for lignite and coal. The C—C bond cleavage and C—O bond cleavage might have taken place as reported by Huber by retro-aldol condensation and decarbonylation. The pH of the solution might not change too much towards acidic conditions and because of this, with a suitable buffer it can be used for the biodegradation and production of methane.
Nickel acetylacetone (Ni Acac): Nickel enolate complexes are recently reported to cleave carbon-carbon bonds in aliphatic environment and subsequent biological systems by Grubel et al [11]. We have introduced for the first time, known nickel enolate complex, nickel acetyl acetone, under ethanol medium. The average percentage consumption of coal was only 8% and lignite was bit better 18%. Enolate complexes are known to be friendly with further bio-treatment as well.
(N,N′Bis(salicylidene)ethanediamino nickel II: Salicylidene compounds with nickel commonly known as Schiff bases promotes a hydrogen bonding environment in the molecular systems. Such characteristics might be suitable to break aliphatic bonds in coal and lignite. Our preliminary investigations showed that both coal and lignite reacted with this reagent and the consumptions were 20 and 25 percentages respectively. Schiff bases are known to be suitable for further use in bacterial degradation without much pretreatment.
CuCl/Sodium phosphate in ethanol: A recent jACS communication accounts for copper catalyzed C—C bond activation[12]. So a combination of CuI in ethanol with sodium phosphate was explored to break chemical bonds in coal and lignite to facilitate the methane production by bacteria. Though, lignite reacted major part consumed, coal reaction was not notable. No conclusive results have been found yet with this experiment.
4,4′-Dipyridyl, FeCl₃ and H₂O₂: The preliminary results showed coal reacted almost 42% whereas no reaction was observed with lignite.

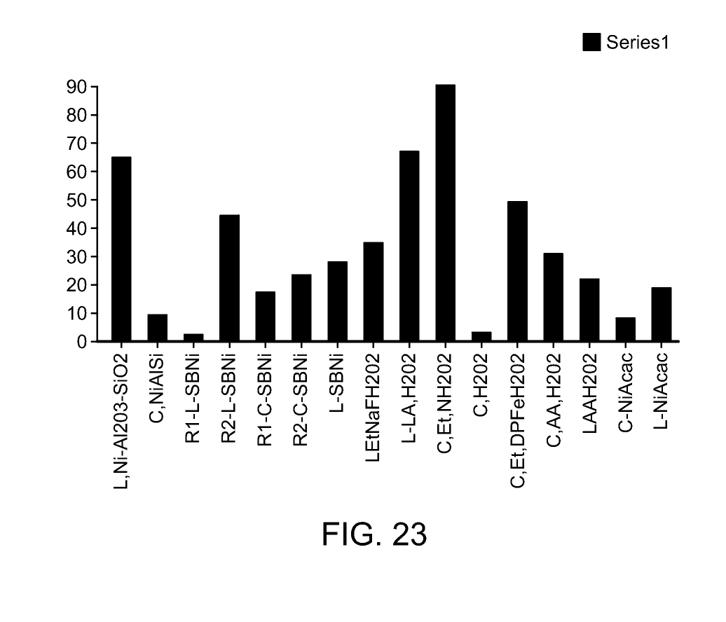

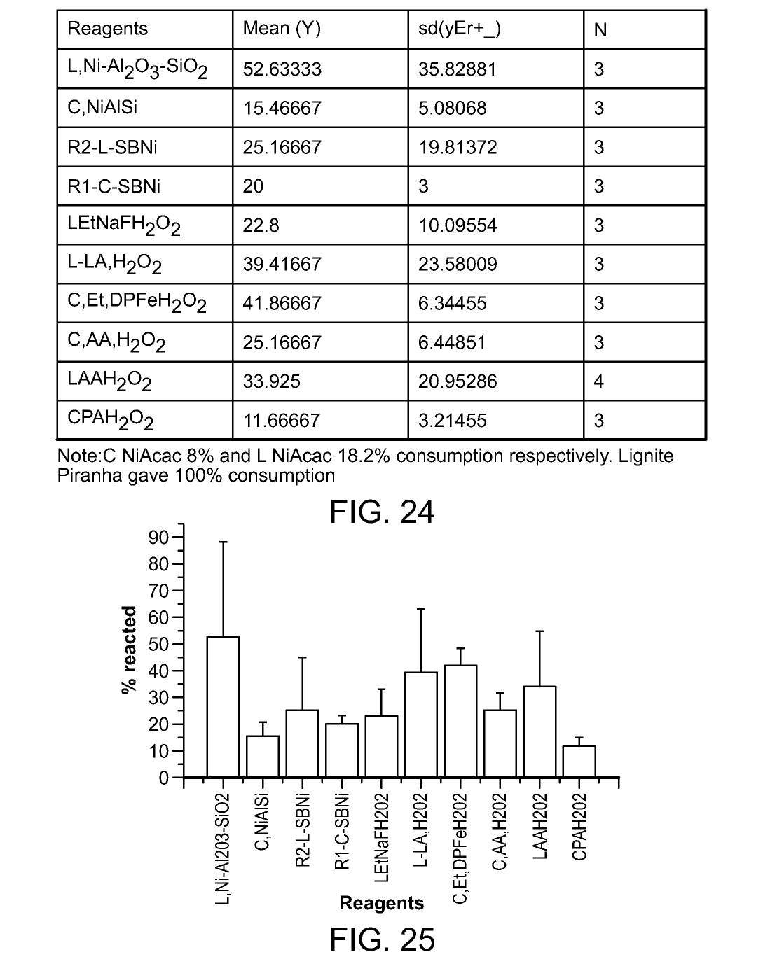

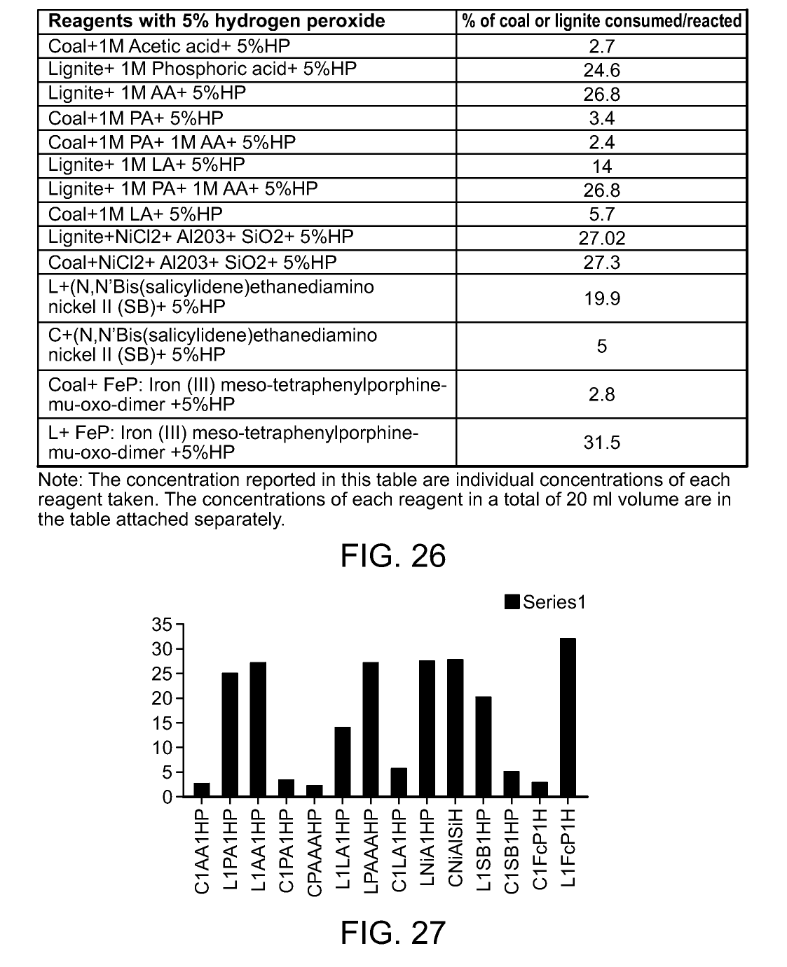

FIG. 23 reports in graph form the percentages of reaction of coal or lignite with a variety of reagents. The table of FIG. 24 reports the standard deviations and mean values of the effectiveness of the reactive reagents on coal or lignite. FIG. 25 reports similar data in a graphical format. FIGS. 26 and 27 report results of similar testing adding 5% hydrogen peroxide to the reagents.

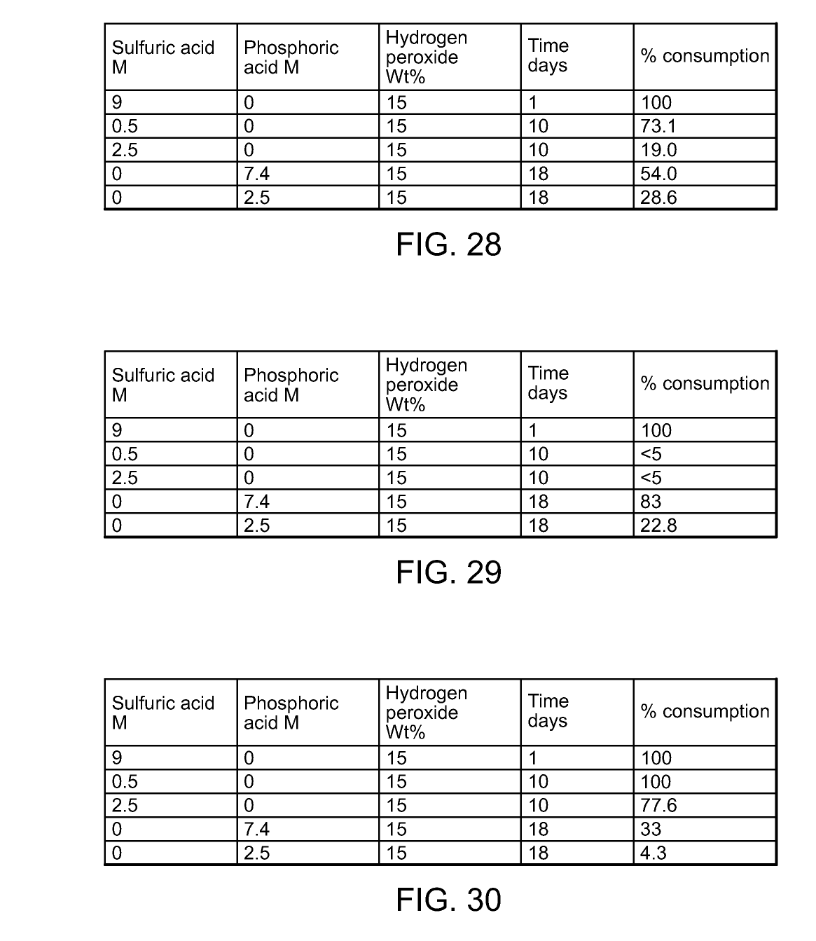

FIGS. 28, 29 and 30 report data on the reactions of corn husks, corn cobs, and corn stems with selected reagents—primarily a combination of sulfuric acid, phosphoric acid, and hydrogen peroxide in different amounts. Corn husk, corn cobs and corn stems were separated and reacted with different concentrations of sulfuric acid, phosphoric acid, lactic acid and acetic acids with hydrogen peroxides to assess the percentage consumption or bond breakage.

The above described testing produced the following conclusions. Though coals have been a good source of bio-energy and studied extensively by chemical pre-treatment before biodegradation, we have shown for the first time some unique combinations as claimed below.

Mixture of Concentrated Sulfuric Acid and Hydrogen Peroxide (Piranha Solution).

The combinations of sulfuric acid and hydrogen peroxide, commonly known as Piranha solution, as a key reagent for the chemical pretreatment of lignite, have been successfully explored. Though piranha with different combinations is known to clean substrates and other oxidation purposes, there is no report of using this pretreatment mixture for coal, waste coal and lignite. In our studies a concentrated sulfuric acid (18M) and 30% hydrogen peroxide (1:1) combination consumed all the lignite in one day. The reaction was highly exothermic and the temperature was helpful for the rapid completeness of the reaction. A brown liquid was remained after the reaction. Coal and waste coal reacted with this concentration of piranha and consumed 31.2% and 28.2 respectively. The actual concentrations of sulfuric acid and hydrogen peroxide in solutions were only 9M and 15% respectively and a separate table is included with the actual concentration in solution with percentage consumption.

In view of designing more environmentally friendly reactant for the lignite, a series of combinations of hydrogen peroxide with sulfuric acid have been examined. The equal volumes (1:1) combinations studied were 1M sulfuric acid with 5% hydrogen peroxide, 1M sulfuric acid with 15% hydrogen peroxide, 1M sulfuric acid with 30% hydrogen peroxide, 5M sulfuric acid with 5% hydrogen peroxide, 5M sulfuric acid with 15% hydrogen peroxide and 5 M sulfuric acid with 30% hydrogen peroxide. Among them, only 30% hydrogen peroxide with 5M sulfuric acid and 15% hydrogen peroxide with 5M sulfuric acid were shown to be higher exothermic reactions with lignite. Hydrogen peroxide concentration increases the reactivity with 5M sulfuric acid.

The novelty of this investigation is the combination of sulfuric acid and hydrogen peroxide for the chemical pretreatment of coal and lignite. The 100% consumption of lignite with this reagent is an interesting investigation. The varying combinations and biofriendly proportions of the reagents are entirely new steps in the biodegradation of coals.

Nickel Chloride/Al₂O₃/SiO₂.

There have been reports of biomass as renewable resources for sustainable energy by making use of the carbon in the system. The challenging part of this work is the selective removal of oxygen from the fuel source. Huber et al reported a Pt/SiO₂—Al₂O₃ system by aqueous phase processing (called APP), where aqueous phase hydrodeoxygenation (APHDO) is the key to convert oxygenated molecules into smaller hydrocarbons with the help of the Pt metal catalyst in combination with Lewis acid (SiO₂—Al₂O₃). This is a bifunctional catalyst system, Pt/SiO₂—Al₂O₃, and the metal behaves as a catalyst for retro-aldol condensation and decarbonylation and the key for dehydration takes place on acid catalyst sites. The reported work was for small molecules and is indicated in the paper that the C—C bond cleavage chemistry via hydrodeoxygenation might be useful if we tune the chemistry to biomass derived oxygenated products.

Inspired by this investigation, we are for the first time exploring similar catalytic combination by replacing the expensive platinum metal with an inexpensive nickel chloride reagent to cleave C—C bond from coal and lignite. We have extracted part of the organic matter from coal and lignite by reacting a small portion of ethanol and further added with very few quantities of nickel chloride and aluminum chloride and silica. In order to enhance the oxidation of the reaction product, 5% hydrogen peroxide was also added.

The novelty of this investigation lies in the introduction of inexpensive nickel chloride in the catalytic system to pretreat and degrade coal successfully for further biotreatment. Such a system does not necessarily need a pH adjustment for the subsequent biological treatment and production of gases.

NaF and H₂O₂.

Though hydrogen peroxide has been reported for the pretreatment of coal and lignite, there is no report of using combinations of NaF and hydrogen peroxide. We have observed 22% reactivity with this combination. There was an initial addition of ethanol to enhance the organic portion from the lignite to react with the reagent. A 30% combination of hydrogen peroxide was used and the reaction mixture was completed and isolated in one day. A more dilute 5% hydrogen peroxide with NaF works with longer reaction time; approximately 3 weeks.

The novelty of this investigation is the combination of NaF and hydrogen peroxide with ethanol. The added advantage of this investigation is the flexibility of the adjustment of concentration of these reagents for an extended period of time.

Nickel Acetylacetone (Ni Acac) and Hydrogen Peroxide.

Recent studies of O₂-dependent aliphatic carbon bond cleavage reactivity in a nickel enolate complex having a hydrogen bond donor microenvironment acireductone type lignad in biological systems, and the similar compounds preparation prompted us to explore more simplified complexes for the bond cleavage. We are reporting the new application of nickel acetyl acetone for bond cleavage applications in coal and lignite. So far there is no report for using this enolate compound to study bond cleavage, though other enolate nickel complexes have been explored for aliphatic bond cleavages. Nickel acetyl acetone, a nickel enolate complex has been explored in this investigation. The average percentage consumption of coal was only 8% and lignite was bit better 18%. We further modified this combination by the addition of a 5% hydrogen peroxide and anticipated an improvement in the bond breakage.

The novelty of this investigation is the unique combination of nickel acetyl acetone and hydrogen peroxide for the successful coal and lignite pretreatment.

(N,N′Bis(salicylidene)ethanediamino nickel II.

There is no report of using this reagent (N,N′Bis(salicylidene)ethanediamino nickel II for chemical pretreatment of coal and lignite. Based on the characteristic property of hydrogen bond containing molecule, this Schiff base molecule was used for bond breakage in coal and lignite after extracting with ethanol to enhance its reactivity. Coal was less reactive (25% consumption) and lignite reactivity was 25% in ethanol. An addition of 5% or more concentrated hydrogen peroxide may improve the reactivity better. We have introduced a new combination of nickel Schiff base with hydrogen peroxide for coal degradation.

4,4′-Dipyridyl, FeCl₃ and H₂O₂.

Ferric iron (Iron III) with dipyridyl and hydrogen peroxide in the presence of methanol at 90° C. for chemical degradation of polychlorinated biphenyls to CO₂ via hydroxyl radical is known to scientists. In view of this invention, we explored this mixture for bond degradation in coal and lignite. We have replaced the solvent methanol with ethanol to make it more biofriendly. Coal reacted 41% with this reactant mixture. The novelty of this mixture is the versatile combination of the dipyridyl, ferric chloride, hydrogen peroxide in ethanol medium under many different concentration formulations.

FeP: Iron (III) meso-tetraphenylporphine-mu-oxo-dimer.

Peroxo-iron mediated C—C bond cleavage for cytochrome P 450 (CYP) have been reported earlier and studied to unravel the mechanism in many interesting articles. In an interesting investigation, individual porphyrins from the heme fraction of Colorado coal have been isolated as iron and gallium porphyrins. In this view, we thought of exploring this iron porphyrin type material for breaking of coal with hydrogen peroxide and we have succeeded with considerable reactivity in breaking down coal and lignite as indicated by the percentage reactivity of coal and lignite. With our breakthrough invention, it might be possible for further breaking of coal or lignite by making use of the iron porphyrin present in it, and the reaction will prolong for a long time when added ethanol and hydrogen peroxide are required. For the first time we explored the unique combination of meso ferric tetraphenylporphyrine dimer with hydrogen peroxide and ethanol in many different concentrations for the successful chemical pretreatment of coals.

Acetic Acid/Lactic Acid/Phosphoric Acid Combinations with Hydrogen Peroxide.

The effect of organic and inorganic acids pretreatment on the structure and pyrolysis reactivity of coals, mild acid pretreatment using aqueous acetic acid or methoxyethoxy acetic acid to remove bridging cations through oxygen functional groups and to improve the pyrolytic reactivity of coal have been reported earlier. Trifluoroacetic acid with hydrogen peroxide is known for breaking aromatic bonds. In understanding the effect of acetic acid/lactic acid/phosphoric acid in combinations with 5% hydrogen peroxide. 1M dilute combinations of these acids with 5% hydrogen peroxide were also studied separately and individually for the first time to break the bonds in coal and lignite. The advantage in this study is we are only using very dilute acids and a dilute 5% hydrogen peroxide by considering the environment for green fuels. A long term exposure of coal and lignite will improve the breaking rate ambient conditions. An average reaction percentage was 26.7% with 1M acetic acid and 5% hydrogen peroxide over a period of 30 days.

The novelty of these investigations lies in the varying combination of acetic acid, lactic acid and phosphoric acid with hydrogen peroxide in the presence and absence of ethanol and urea. These bio-friendly combinations are good candidates for the bacteria to grow for successful methane production. More diluted combinations for long term experiments are in progress as in the attached table with three coals.

A particular delivery fluid may include one or more selected chemical compounds and/or microbes (discussed above). The fluids and/or microsolids may function as fracturing fluids and/or materials as well as delivery fluids. The fluids may be in the form of liquids, aerosols, foams, mists, etc. The fluids and/or micro-solids may include one or more solid components, such as flakes, particulates, fine meshed sands, proppant for fracturing (e.g., sand, ceramics, bauxite, or other particulates). Some components within a delivery fluid may be encapsulated within a capsule. Standard geological methods employed by the mining industry, the petroleum industry, and others, may be used to deliver such fluids. For example, methods for delivering fluids to a carbon-containing site at the surface or slightly below the surface may include, but are not limited to, closed reactor applications, sprayed applications, leaching applications, in situ treatments, surface applications (i.e., through ponds, ditches, diffusers, etc.), injection well applications. Methods for delivering fluids to subterranean sites (e.g., through a hole drilled in the surface) may include, but are not limited to periodic or continuous injection, continuous injection followed by flowback or production into reactors, in situ reactors, or offset wells, cyclic injection and production sequences with soaking times, and/or staged injections (e.g., of liquids, aerosols, gels, gases, etc.).

Prior to injecting fluids into a site, mechanical means first may be used to alter the physical conditions of a particular site. For example, drilling may be used to create injection/bore holes and/or to fracture solids. Cavitation (i.e., rapidly injecting air into a site) also may be used to fracture solids. Mechanical fracturing may be used to provide access to solids otherwise not accessible to bacteria within the site, to increase the surface area of solids, to deliver gasses (e.g., CO2), etc. Use of underground thermal energy storage mechanisms, and expansion and compression of fluids, aerosols, and gases, to adjust temperatures/conditions within surface reactors, in situ reactors, and in situ sites.

Each time a fluid is delivered to a site, the fluid may adjust the physical, chemical and/or biological characteristics of the site. In some processes, a carbon-containing material may be pre-treated with chemicals prior to injecting a microbial consortium so as to adjust the chemical and thermal environment of the site, and/or to degrade hydrocarbons to products more readily digestible by bacteria. Any of the chemical compounds discussed above could be used to pre-treat a site. In some processes, a fluid containing a selected bacterial consortium and one or more selected chemical compounds may be pre-mixed prior to delivering the fluid to the site so as to reduce the number of required injections.

Each injection may be used to fracture the solids within a site containing a carbon-containing material. Hydraulic fracturing may be desirable in situations where the permeability of solids within a particular site is too low to allow injection of a fluid. The fracturing fluid may be injected at pressures capable of fracturing the solids within the site and may be composed of one or more fracturing agents (e.g., proppant or other chemical compounds that induce or maintain fracturing). As with mechanical fracturing, hydraulic fracturing may be used to provide access to solids otherwise not accessible to bacteria within the site, increase the surface area of solids, deliver gasses and remove coal fines, and to adjust environmental temperatures. In some processes, the fracturing fluids may contain other chemical compounds and/or a bacterial consortium along with a proppant, such that the chemical compounds and/or bacterial consortium are delivered throughout the fracture along with the proppant. The chemical compounds and/or bacterial consortium may then be able to digest coal fines that may make their way into the fracture, thereby preventing or inhibiting the fines from blocking the proppant-packed fractures.

The delivery and/or fracturing fluids disclosed herein may be in the form of liquids, aerosols, foams, mists, etc. Aerosols may be generated with sub-micron particle generators, misters, pressure injectors, etc. Aerosols may more readily penetrate into small channels, spaces and other formations that may be substantially impermeable to liquids, and may permit the use of lower volumes of fluid. Foams may be formed by rapidly mixing gasses (e.g., N2 and CO2) with a solution optionally containing a foaming agent or other dispersant. Foams also may permit the use of lower volumes of liquids, and may help to control fluid loss.

Some components within a delivery fluid, such as a bacterial consortium, enzyme preparation, and/or one or more chemical compounds, may be encapsulated within a capsule. Materials that may be used to encapsulate components include, but are not limited to, hydroxypropyl guars, celluloses and other polysaccharides, agaroses, gelatins, alginates, guars, acrylamides, polyacrylics, etc. Encapsulation may allow for the delivery of self-contained (i.e., protected) mixtures, may immobilize contained components during introduction to a site, may allow for potential nutrient and time release, and may improve fracturing (e.g., the capsule may function as a proppant).

Microencapsulation is a process that allows liquid or solid substances to be covered by a barrier wall. The wall must be chemically inert to the content of the capsule and possess an adequate stability to mechanical, thermal or chemical influence. Microencapsulation by phase separation from aqueous solution systems, in situ polymerization and interfacial polymerization are often useful. Diameters of the capsules that can be produced range from 1 μm to 1200 μm. However, because of the multitude of factors that must be taken into account when designing and preparing microcapsules, it is likely that microencapsulation will remain, to some extent, an art.

There are four typical mechanisms by which the core material is released from a microcapsule—mechanical rupture of the capsule wall, dissolution of the wall, melting of the wall, and diffusion through the wall. Less common release mechanisms include ablation (slow erosion of the shell) and biodegradation. Microencapsulation research, development, and prototype production has been completed in many areas to develop custom encapsulations that meet specific requirements for: size; payload; chemical resistance; thermal stability; release control; physical strength; and shelf life. Microencapsulation techniques involve disciplines of chemistry, biochemistry, pharmaceutics, automation, process control, polymers, fluid dynamics, environmental engineering, and materials development and testing, among others to develop microencapsulation solutions for a variety of applications.

Consumer products utilizing encapsulation include detergents, bleaches, cosmetics, over-the-counter medicines, floor polishes, carpet cleaners, deodorants, toothpastes, paints, photographic film, and adhesives. Reactive and bioreactive materials can also be prepared including catalysts, oxidizers, reducers, active biological materials, and volatile compounds. An understanding of aerial and ground crop spraying equipment, microcapsules can be developed for a variety of applications. A broad spectrum of materials can be encapsulated for release under a variety of conditions or mechanisms, such as: diffusion; pressure; solubilization; temperature; photolysis; biodegradation (bioerosion in the body and microbial attack in the environment); and particle size.

Microencapsulation allows for controlled release, specifically sustained, delayed, or targeted releases. A slow release of a material over time or conditions allows materials to perform more effectively. Delayed release at a specific time or condition can stabilize catalysts and microorganisms. Examples of targeted release include a microencapsulated pesticide, enzyme, microbial preparation, or various chemical packages targeted for a particular actions or delayed release of a staged series of actions or supportive releases. A more complete list of benefits includes: sustained release of materials; slow release of materials; isolation of synergistic or staged materials; delayed release of biocontrol or biotreatment agents; shelf-life extension of above materials; heat release of ingredients of above materials; triggered releases of various materials; release-on-demand of various materials; controlled release of environmental application additives such as for oil wells; protection of biological materials used in pollution remediation; high binding capacity and temperature stability of streptavidin-coated microspheres are useful for a variety of applications; isolation of reactive materials; and protection of catalysts and other biological materials.

Technologies such as rotating disks produce prills and overcoats of solids. Polymer solutions and hot melts are can be used to prepare particles ranging from 25 μm to 1 mm in size. Fluidized bed coating processes uniformly coat solids larger than 100 μm. Hot melts and aqueous or solvent-based solutions can be used to spray-coat batches. Various barrier wall materials may be utilized during encapsulation which are dependent upon the application of the following substances including: gelatins, gums, guars, sugars, proteins, cellulitic materials, starches; semi-synthetic polymers, such as, acetates and hydroxypropylcellulose; and synthetic polymers, such as, acrylpolymers, PEG, PVCs, polyethylene, PVAs, polyesters, urethanes, and similar materials.

A broad range of hydrophilic and lipophilic shell materials, including commercially available synthetic polymers and natural gums, waxes, and resins as are other polyimmidizole, PEG, acrylimides, sugars, proteins, ammonium chlorides, alginates, agars, guars, N-hydroxyalkyl-D,L-glutamine, compatibilized blends, copolymerization of some conventional polymer films, peroxides and hydroperoxides, 2,2-diphenyl-1-picrylhydrazyland, photoreactive polymers of 4-vinylbenzyl thiocyanates, styrenes, other materials are readily available for use. Using advanced technology and novel methods, capsule payloads, release kinetics, and particle size can be adjusted to suit specific applications. The analytical and process equipment needed or useful in such research includes: particle preparation equipment; ball mill; centrifugal grinding mill; mortar grinder; homogenizer; micro-fluidizer; sonifiers; sonic sieve; evaluation equipment; coulter counter; computer vision particle analyzer; scanning electron microscope; optical microscopes; hardness tester; mechanical force gauge; tensiomat; dissolution testers; friabilator; chemical analysis equipment; Fourier transform infrared spectrophotometer; gas chromatograph/mass spectrometer; high-performance liquid chromatograph; nuclear magnetic resonance spectrometer; differential scanning calorimeter; and rheological equipment.

Stationary and submerged nozzles produce capsules ranging in size from 500 μm to 6 mm in diameter. Advanced aerosol generation equipment can produce particles in the 1 to 10 micron range. These methods are used to coat various types of specialty materials including aqueous fill materials with wax blends, carrageenan blends, gelatins or other materials. Vibration can be coupled with specialty nozzle system to develop microcapsules in narrow size distributions. Centrifugal extrusion systems can produce large volumes of capsules a minute. Liquids, gases, and slurries can also be encapsulated ranging in size from <50 μm to 100 μm.

Consider, for example, the process called complex coacervation. Conceived in the 1930's by colloid chemist Barrett Green at the National Cash Register Corporation, it was the first process used to make microcapsules for carbonless copy paper. In complex coacervation, the substance to be encapsulated is first dispersed as tiny droplets in an aqueous solution of a polymer such as gelatin. For this emulsification process to be successful, the core material must be immiscible in the aqueous phase.

Miscibility is assessed using physical chemistry and thermodynamics. The emulsification is usually achieved by mechanical agitation, and the size distribution of the droplets is governed by fluid dynamics. A second water soluble polymer, such as gum arabic, is then added to this emulsion. After mixing, dilute acetic acid is added to adjust the pH. Though both polymers are soluble in water, addition of the acetic acid results in the spontaneous formation of two incompatible liquid phases. One phase, called the coacervate, has relatively high concentrations of the two polymers; the other phase, called the supernatant, has low polymer concentrations. The concentrations of the polymers in these two phases, and the pH at which phase separation occurs, are governed by specific properties of physical chemistry, thermodynamics, and polymer chemistry.

If the materials are properly chosen, the coacervate preferentially adsorbs onto the surface of the dispersed core droplets, forming microcapsules. Again, physical chemistry and thermodynamics dictate whether the coacervate adsorbs onto the core material. The capsule shells are usually hardened first by cooling (heat transfer), and then by chemical reaction through the addition of a cross-linking agent such as formaldehyde (polymer chemistry). The release characteristics of the microcapsules are governed by materials science (mechanical), heat transport (thermal release), and mass diffusion (diffusion through the wall).

Each aspect of this process is highly dependent upon the others. For example, the thermodynamics of the phase separation affects the composition of the shell material, and this affects the ability of the shell to wet the core phase, as well as determining the barrier properties and release characteristics. Despite extensive research to fully comprehend the coacervation process, it has been almost impossible to study the influence of each of these factors on an individual basis. Furthermore, answers to some questions—how fast should the pH be lowered, how can agglomeration and formation of free coacervates be avoided, what are the effects of rapid cooling—remain qualitative. Considering the difficult questions involved, the interconnectivity of different process elements, and the fact that there are hundreds of encapsulation process variations, it is little wonder that microencapsulation is sometimes regarded as an art.

Though it sounds deceptively simple, co-extrusion capsule formation is quite complicated. The size of the capsules produced, as well as the quantity of core material contained within each capsule, depends on the physical properties of the fluids (densities, viscosities, and interfacial tensions), the processing conditions (flowrates and temperatures), the geometry of the nozzle (diameters of the inner and outer orifices), and the amplitude and frequency of small vibrational disturbances (natural or imposed) present in the system. Because there are so many variables, and because it is often difficult to vary one without affecting another (for example, changing the viscosity of the shell fluid changes the interfacial tension between it and the surrounding fluid, and between it and the core fluid), it is extremely difficult to isolate the influence of the individual factors. For this reason, co-extrusion processes are designed, and operating conditions determined, on a case-by-case basis.

Nevertheless, the principles of momentum conservation and fluid mechanics relevant to capsule formation processes provide a framework on which Institute researchers are developing a fundamental understanding of capsule formation by co-extrusion.

Alginate Bead Procedure.

Depending on the flow rates of core and shell materials, capsules are formed in one of two modes: drip or jet. In drip mode, core and shell liquids flow out of the concentric orifices at a low rate, and a compound drop begins to form at the nozzle tip. As is the case with a slowly dripping faucet, surface tension prevents the compound drop from immediately separating from the orifice. However, once it is large enough, the weight of the drop overcomes the cohesive force of surface tension, and the drop falls from the nozzle. As long as the fluid flow rates and temperatures remain constant, this process can produce uniform sized, but fairly large, capsules. In a project for the U.S. Bureau of Mines, both microbes and extracted enzyme preparations were tested for remediation purposes.

Core and shell solutions can be delivered to a nozzle (a small diameter syringe needle) at a rate of 0.5 milliliter per minute. A stream of air was forced to flow around the needle tip to accelerate the rate of detachment of capsules from the nozzle tip. This resulted in the formation of smaller capsules (approximately 700 microns) compared to the size of those formed without the air stream. The liquid capsules were collected in an aqueous solution of calcium chloride. In this solution, a chemical reaction occurs, in which the water soluble sodium alginate is converted to an insoluble calcium alginate gel.

Although drip mode produces uniform capsules, the production rate is quite low (approximately 20 to 30 capsules per minute). Increased output can only be realized by using multiple nozzles. However, pumping and capsule collection equipment can be scaled considerably before costs become prohibitive.

If the flow rates of the core and shell materials are increased beyond some critical value, capsules do not take shape at the nozzle tip. Rather, a compound jet, consisting of a jet of core fluid encased by a sheath of shell fluid, is formed. The critical flow rate is the flow rate at which the inertial force associated with the velocity of the flowing fluid just exceeds the surface tension force, which tends to cause fluid to adhere to the nozzle tip.

The immobilization of enzymes in alginate gel is particularly beneficial in the present invention. Alginate, commercially available as alginic acid, sodium salt, commonly called sodium alginate, is a linear polysaccharide normally isolated from many strains of marine brown seaweed and algae, thus the name alginate. The copolymer consists of two uronic acids: D-mannuronic acid (M) and L-guluronic acid (G). Because it is the skeletal component of the algae it has the nice property of being strong and yet flexible.

Alginic acid can be either water soluble or insoluble depending on the type of the associated salt. The salts of sodium, other alkali metals, and ammonia are soluble, whereas the salts of polyvalent cations, e.g., calcium, are water insoluble, with the exception of magnesium. Polyvalent cations bind to the polymer whenever there are two neighboring guluronic acid residues. Thus, polyvalent cations are responsible for the cross-linking of both different polymer molecules and different parts of the same polymer chain. The process of gelation, simply the exchange of calcium ions for sodium ions, is carried out under relatively mild conditions. Because the method is based on the availability of guluronic acid residues, which will not vary once given a batch of the alginate, the molecular permeability does not depend on the immobilization conditions. Rather, the pore size is controlled by the choice of the starting material.

2Na(Alginate)+Ca⁺⁺- - - - - - ->Ca(Alginate)₂+2Na⁺

The ionically linked gel structure is thermostable over the range of 0-100° C.; therefore heating will not liquefy the gel. However, the gel can be easily redissolved by immersing the alginate gel in a solution containing a high concentration of sodium, potassium, or magnesium. Maintaining sodium:calcium<=25:1 will help avoid gel destabilization. In fact, it is recommended by alginate vendors to include 3 mM calcium ions in the substrate medium. On the other hand, citrate or phosphate pH buffers cannot be effectively used without destabilizing the alginate gel.

Alginate is currently widely used in food, pharmaceutical, textile, and paper products. The properties of alginate utilized in these products are thickening, stabilizing, gel-forming, and film-forming. Alginate polymers isolated from different alginate sources vary in properties. Different algae, or for that matter different part of the same algae, yield alginate of different monomer composition and arrangement. There may be sections of homopolymeric blocks of only one type of monomer (-M-M-M-) (-G-G-G-), or there may be sections of alternating monomers (-M-G-M-G-M-). Different types of alginate are selected for each application on the basis of the molecular weight and the relative composition of mannuronic and guluronic acids. For example, the thickening function (viscosity property) depends mainly on the molecular weight of the polymer; whereas, gelation (affinity for cation) is closely related to the guluronic acid content. Thus, high guluronic acid content results in a stronger gel.

A preferred procedure for immobilizing enzymes in alginate gel is as follows. First, dissolve 30 g of sodium alginate in 1 liter of solvent, i.e., deionized water, to make a 3% solution. Sodium alginate solution is best prepared by adding the powder to agitated water, rather than vice versa, to avoid the formation of clumps. Prolonged stirring may be necessary to achieve the complete dissolution of sodium alginate. After sodium alginate is completely dissolved, leave the solution undisturbed for 30 minutes to eliminate the air bubbles that can later be entrapped and cause the beads to float.

Next, approximately 0.015 g of enzyme is mixed with 10 ml of 3% (wt.) sodium alginate solution. The concentration of sodium alginate can be varied between 6-12% depending on the desired hardness. Although not necessary, the beads may be hardened by mixing some amines in the sodium alginate solution and cross-linking with glutaraldehyde.

Finally, the beads are formed by dripping the polymer solution from a height of approximately 20 cm into an excess (100 ml) of stirred 0.2M CaCl2 solution with a syringe and a needle at room temperature. The bead size can be controlled by pump pressure and the needle gauge. A typical hypodermic needle produces beads of 0.5-2 mm in diameter. Other shapes can be obtained by using a mold whose wall is permeable to calcium ions. Leave the beads in the calcium solution to cure for 0.5-3 hours. Because of the mild conditions needed for gelation, calcium alginate is also widely used for cell immobilization.

Alternatively, the enzymes may be immobilized in polyacrylamide gel. This technique is based on the polymerization of acrylamide with N,N′-methylene-bis-acrylamide (Bis) as the cross-linking agent. The degree of cross-linking, thus, can be partly controlled by adjusting the ratio of acrylamide to Bis used. The procedure begins with the creation of a buffered monomer solution. To do this, one adds 1.1 g of Bis and 20 g of acrylamide to 100 ml of buffered solution (pH 7.0) of 0.1 mM EDTA and 0.1 M Tris-HCl in a beaker. The pH of the buffer should be adjusted to match the optimum value of the enzyme to be entrapped.

Enzyme powders (approximately 0.1 ml of 75 g/l fungal amylase or an equivalent concentrated enzyme solution) are added to 10 ml of the buffered monomer solution of the above step and mixed. For 20 minutes, purge the dissolved oxygen in the solution that can interfere with the polymerization process with nitrogen. This step is critical in achieving a high degree of cross-linking. Next add 0.1 ml of dimethylaminopropionitrile and mix again. Then add 1.0 ml of freshly prepared 10 g/l potassium persulphate solution to initiate polymerization.

The next step is to pour the solution into a mold if one does not desire the gel to form in the original beaker. Leave the solution undisturbed and the gel will form in approximately 10-30 minutes. Hardening may be accelarated by using more dimethylaminopropionitrile. Then the resulting gel is cut into small cubes of approximately 3 mm per side. Alternatively, if smaller pieces are desired, the gel can be forced through a syringe fitted with a fine needle. Finally, gently wash the free enzyme off the gel surface in 10 ml of washing solution. The washing process may be repeated two additional times.

All of the above techniques may be used to provide conditions and processes for optimizing methanogenesis. Various experiments have been performed and described to identify conditions and processes that allow for optimal methanogenesis.

Control the Conditions within the Site to Optimize the Conditions.

Once optimal conditions and processes have been identified, those processes will be implemented. This may involve determining and preparing the types/amounts of delivery and/or fracturing fluids that must be added to create the selected optimal conditions for methanogenesis, performing any mechanical fracturing, and introducing delivery and/or fracturing fluids into the site. These steps may be performed according to the process deemed necessary to provide optimal conditions for methanogenesis (discussed above). During or after performance of one or more process steps, the effects of controlling the conditions may be assessed by taking and analyzing soil, water and air samples to determine whether the conditions are, in fact, optimal.

Repeat One or More Steps to Optimize Conditions in a Site.

Optimization may include modifying conditions to address unexpected changes in the chemical, physical and/or biological conditions within the site, maintaining conditions for methanogenesis, forming gradients that induce a desired and gradual chemical and biological effect that promotes carbonaceous material degredation and subsequently methanogenesis, introducing microorganisms and/or chemical compounds into a site in staged sequences via continuous or periodic (e.g. cyclic) injection of specific types and amounts of microorganisms chemicals.

The processes disclosed herein are not limited in their applications to the details described herein, and are capable of other embodiments and of being practiced or of being carried out in various ways. Also it is to be understood that the phraseology and terminology used herein is for the purpose of description only, and should not be regarded as limiting. Ordinal indicators, such as first, second, and third, as used in the description and the claims to refer to various structures, are not meant to be construed to indicate any specific structures, or any particular order or configuration to such structures. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

Further, no admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein.

Although several embodiments have been described in detail for purposes of illustration, various modifications may be made without departing from the scope and spirit of the invention. Accordingly, the invention is not to be limited, except as by the appended claims.

What is claimed is:

1. A method for enhancing biogenic methanogenesis in a carbon-containing material, comprising:
evaluating existing geophysical conditions within a site comprising the carbon-containing material;
identifying optimal geophysical conditions within the site for biogenic methanogenesis;
introducing an enhancing fluid into the site configured to alter the existing geophysical conditions within the site;
assessing the altered geophysical conditions within the site;
comparing the altered geophysical conditions to the optimal geophysical conditions;
repeating the steps of evaluating, introducing, assessing, and comparing such that the altered geophysical conditions more closely resemble the optimal geophysical conditions.

2. The method of claim 1, wherein the geophysical conditions comprise physical structure, physical characteristics, and chemical/biological characteristics.

3. The method of claim 2, wherein the physical structure comprises the form of the site, including concentrated solids, liquids, gasses, shales, or sands, the location of the site, and the physical accessibility of the carbon-containing materials in the site.

4. The method of claim 2, wherein the physical characteristics of the site comprise temperature, pressure, pH, redox conditions, and the types and amounts of the carbon-containing materials.

5. The method of claim 2, wherein the chemical/biological characteristics comprise salinity, acidity, concentration of oxygen, concentration of organic chemicals, concentration of inorganic chemicals, and types and populations of microorganisms.

6. The method of claim 1, wherein the identifying step includes identifying optimal physical conditions, optimal biological conditions, or optimal physiochemical conditions within the site.

7. The method of claim 6, wherein the identifying step includes the step of determining whether the optimal physical conditions within the site require fracturing, drilling or cavitating of the carbon-containing material.

8. The method of claim 1, wherein the introducing step includes the step of mixing one or more types of microorganisms or one or more types of chemicals to form the enhancing fluid.

9. The method of claim 8, wherein the types of microorganisms include naturally occurring, methanogens, acidophiles, halophiles, thermophiles, thermoacidophiles, nitrospirae, acidithiobacilli, pseudonomads, callulomonadaceae, aechaea, and sulfate reducing bacteria.

10. The method of claim 9, wherein the microorganisms are genetically engineered, hybridized, isolated, or reproduced, and are obtained from ruminant animal manure, wetlands, wastewater treatment environs, bogs, and natural coal bed environs.

11. The method of claim 1, wherein the introducing step includes the step of mechanically altering the carbon-containing material in the site.

12. The method of claim 11, wherein the mechanically altering step includes drilling injection holes; fracturing solids; inducing air cavitation;
expansion or compression of fluids, aerosols, or gasses; and adjusting the temperature within surface reactors.

13. The method of claim 11, wherein the mechanically altering step includes injecting a fracturing fluid comprising a consortium of one or more types of microorganisms and one or more organic compounds, wherein the fracturing fluid causes a carbon source within the carbon-containing material to fracture.

14. The method of claim 1, wherein the introducing step includes the steps of encapsulating one or more types of microorganisms to form a capsule; and introducing the encapsulated microorganisms into the carbon-containing material.

15. The method of claim 14, wherein the encapsulating step comprises combining the enhancing fluid with hydroxypropyl guars, polysaccharides, celluloses, agaroses, gelatins, alginates, guars, acrylamides, and plyacrylics.

16. The method of claim 1, wherein the introducing step includes adding chemical compounds to the enhancing fluid, wherein the chemical compounds comprise organic compounds, inorganic compounds, nutrients, redox agents, acids, bases, surfactants, enzymes, or catalysts.

17. The method of claim 1, wherein the introducing step comprises adding a pre-treatment fluid to the site, wherein the pre-treatment fluid comprises one or more chemical compounds without any microorganisms; and subsequently introducing the enhancing fluid to the site.

18. The method of claim 1, further comprising the step of pre-mixing one or more types of microorganisms and one or more chemical compounds to form the enhancing fluid.

19. The method of claim 1, wherein the enhancing fluid comprises a liquid, an aerosol, a foam, or a mist, and the enhancing fluid includes flakes, particulates, fine meshed sands, or proppants.

20. The method of claim 1, wherein the enhancing fluid contains a balance of Carbon, Nitrogen, Phosphorus, and Sulfur in the following ratio ranges: 80-160:5-40:0.5-15:1-5.

21. The method of claim 20, wherein the balance of Carbon, Nitrogen, Phosphorus, and Sulfur is in the ratio of 120:20:4:1.

22. The method of claim 1, wherein the repeating step includes repeating the introducing step with a different enhancing fluid until one or more of the altered geophysical conditions is identical to one or more of the optimal geophysical conditions.
